(19) United States
(12) Patent Application Publication
(10) Pub. No.: US 2025/0343359 A1
(43) Pub. Date: Nov. 6, 2025

(54) SPARSE GRADIENT DIELECTRIC LENS FOR IMPROVING FIELD OF VIEW

(71) Applicant: ROGERS CORPORATION, Chandler, AZ (US)

(72) Inventors: Shailesh PANDEY, Chandler, AZ (US); Yajie CHEN, Chandler, AZ (US); Kristi PANCE, Chandler, AZ (US); John DOBRICK, Chandler, AZ (US); Vitali JUDIN, Chandler, AZ (US)

(21) Appl. No.: 19/199,591

(22) Filed: May 6, 2025

Related U.S. Application Data
(60) Provisional application No. 63/643,041, filed on May 6, 2024.

(51) Int. Cl. H01Q 15/08; H01Q 1/38; H01Q 1/48; H01Q 21/06

(52) U.S. Cl. CPC H01Q 15/08; H01Q 1/38; H01Q 21/065; H01Q 1/48

(57) ABSTRACT

An antenna assembly includes a substrate stack 105 comprising a magnetodielectric material, at least one patch radiating element 102 on an upper surface of the substrate stack 105, and a dielectric cover 200 including a gradient lens 204 disposed over the substrate stack 105. The gradient lens 204 includes a first lens portion having a first dielectric constant, Dk_{L1}, and a second lens portion having a second dielectric constant, Dk_{L2}, different from the first dielectric constant, Dk_{L1}.

### CROSS REFERENCE TO RELATED APPLICATION

This application claims the benefit of U.S. application No. 63/643,041, filed May 6, 2024, which is incorporated by reference in its entirety herein.

### BACKGROUND

The present disclosure relates generally to antennas, and more particularly to an L-band cross-dipole antenna.

In the realm of satellite communications, particularly within the Inmarsat Band frequencies ranging from approximately 1.518 gigahertz (GHz) to 1.675 GHz, there exists a significant challenge in antenna design to meet stringent performance criteria. Traditional GPS antennas, tailored for these applications, necessitate a broad field of view, specifically + or −75 degrees, to ensure reliable communication irrespective of the satellite's position relative to the moving user. This wide field of view is crucial for maintaining consistent connectivity with Inmarsat satellites, which provide a variety of communication services across maritime, aviation, and terrestrial platforms. However, achieving this level of performance with a single radiator antenna design has proven to be inadequate. The inherent limitations of single radiator configurations fail to encompass the required angular range effectively, leading to suboptimal reception and compromised communication integrity in diverse operational scenarios.

To address these challenges, current antenna designs for Inmarsat Band applications have evolved towards more complex configurations, employing multiple radiators to fulfill the requisite field of view and frequency band performance. While these multi-radiator systems successfully achieve the desired coverage and signal reception quality, they introduce drawbacks in terms of increased size and weight. Such characteristics are particularly disadvantageous in applications where space is at a premium and efficiency is paramount, including on aircraft and vessels. The bulkier arrangement of these antennas not only impacts the physical and aerodynamic profile of the platforms on which they are mounted but also complicates installation and maintenance procedures. Consequently, there is a pressing need for innovative antenna designs that can reconcile the demand for wide field of view and high-frequency performance with the imperative for compactness and efficiency.

### BRIEF SUMMARY

According to a non-limiting embodiment, an antenna assembly includes a substrate stack comprising a magnetodielectric material, at least one patch radiating element on an upper surface of the substrate stack, and a dielectric cover including a gradient lens disposed over the substrate stack. The gradient lens includes a first lens portion having a first dielectric constant, Dk_{L1}, and a second lens portion having a second dielectric constant, Dk_{L2}, different from the first dielectric constant, Dk_{L1}.

In addition to one or more of the features described above, or as an alternative to any of the foregoing embodiments, the at least one patch radiating element comprises metal.

In addition to one or more of the features described above, or as an alternative to any of the foregoing embodiments, the at least one patch radiating element includes a plurality of patch radiating elements.

In addition to one or more of the features described above, or as an alternative to any of the foregoing embodiments, the plurality of patch radiating elements 102 are arranged as orthogonal patch dipole radiating elements to establish a cross-dipole.

In addition to one or more of the features described above, or as an alternative to any of the foregoing embodiments, the substrate stack comprises: a low-loss substrate comprising a low-loss material; and a magnetodielectric substrate comprising the magnetodielectric material.

In addition to one or more of the features described above, or as an alternative to any of the foregoing embodiments, the low-loss substrate has a dielectric constant, Dk₁, ranging from 2.9 to 3.1.

In addition to one or more of the features described above, or as an alternative to any of the foregoing embodiments, the magnetodielectric material has a dielectric constant, Dk₃, ranging from 11.90 to 12.05, and permeability, μ, ranging from 6.50 to 7.60.

In addition to one or more of the features described above, or as an alternative to any of the foregoing embodiments, the low-loss substrate and the magnetodielectric substrate are separated from one another by a layer of air with a dielectric constant of 1.0.

In addition to one or more of the features described above, or as an alternative to any of the foregoing embodiments, a dielectric substrate interposed between the low-loss substrate and the magnetodielectric substrate.

In addition to one or more of the features described above, or as an alternative to any of the foregoing embodiments, the dielectric substrate comprises a dielectric material having a dielectric constant, Dk₂, ranging from 1.0 to 1.4.

In addition to one or more of the features described above, or as an alternative to any of the foregoing embodiments, the dielectric constant, Dk₂, is 1.3.

In addition to one or more of the features described above, or as an alternative to any of the foregoing embodiments, a ground plane on which the magnetodielectric substrate is disposed.

In addition to one or more of the features described above, or as an alternative to any of the foregoing embodiments, the second lens portion surrounds the first lens portion.

In addition to one or more of the features described above, or as an alternative to any of the foregoing embodiments, the second dielectric constant, Dk_{L2}, that is greater than the first dielectric constant, Dk_{L1}.

In addition to one or more of the features described above, or as an alternative to any of the foregoing embodiments, the first dielectric constant, Dk_{L1}, ranges from 1.0 to 2.7, and the second dielectric constant, Dk_{L2}, ranges from 2.5 to 5.10.

In addition to one or more of the features described above, or as an alternative to any of the foregoing embodiments, the dielectric cover (also referred to herein as the dielectric lens) further comprises sidewalls extending orthogonally from the gradient lens and defining an inner cavity in which the substrate stack is disposed.

In addition to one or more of the features described above, or as an alternative to any of the foregoing embodiments, the sidewalls comprises a dielectric material.

In addition to one or more of the features described above, or as an alternative to any of the foregoing embodiments, the sidewalls and gradient lens extend along an X-axis to define a length, a Y-axis to define a width, and a Z-axis to define a thickness.

In addition to one or more of the features described above, or as an alternative to any of the foregoing embodiments, the first dielectric constant, Dk_{L1}, is 2.5; the second dielectric constant, Dk_{L2}, is 2.9; the length is 6.15 inches (156.21 mm); the width is 6.15 inches (156.21 mm); and the thickness is 1.97 inches (50.038 mm).

In addition to one or more of the features described above, or as an alternative to any of the foregoing embodiments, the first dielectric constant, Dk_{L1}, is 1.50; the second dielectric constant, Dk_{L2}, is 5.07; the length is 4.6 inches (116.84 mm); the width is 6.15 inches (116.84 mm); and the thickness is 1.22 inches (30.988 mm).

In addition to one or more of the features described above, or as an alternative to any of the foregoing embodiments, the sidewalls extend inward toward the inner cavity to define a tapered profile.

In addition to one or more of the features described above, or as an alternative to any of the foregoing embodiments, the sidewalls taper inward at an draft angle ranging from 20 degrees to 30 degrees.

In addition to one or more of the features described above, or as an alternative to any of the foregoing embodiments, the gradient lens includes an intermediate lens region with one or more dielectric constant values, Dk_{LX}, that gradually decrease from the second lens portion having Dk_{L2} to the first lens portion having Dk_{L1}.

In addition to one or more of the features described above, or as an alternative to any of the foregoing embodiments, the dielectric cover comprises: a base having a circular profile defined by a first diameter; and a circular sidewall extending orthogonally from the base and defining an inner cavity configured to receive the substrate stack, wherein the gradient lens is disposed on an upper surface of the circular sidewall and has a circular profile defined by a second diameter.

In addition to one or more of the features described above, or as an alternative to any of the foregoing embodiments, the second dielectric constant, Dk_{L2} is 2.59; the first diameter is 12 inches (304.8 mm); and the second diameter is 9 inches (228.6 mm).

According to another non-limiting embodiment, a dielectric cover is configured to increase a field of view (FOV) of a patch antenna. The dielectric cover includes at least one sidewall defining an inner cavity configured to receive the patch antenna and a a gradient lens disposed on an upper surface of the at least one sidewall. The gradient lens includes a first lens portion having a first dielectric constant, Dk_{L1}, and a second lens portion having a second dielectric constant, Dk_{L2}, different from the first dielectric constant, Dk_{L1}.

In addition to one or more of the features described above, or as an alternative to any of the foregoing embodiments, the second dielectric constant, Dk_{L2}, that is greater than the first dielectric constant, Dk_{L1}.

In addition to one or more of the features described above, or as an alternative to any of the foregoing embodiments, the first dielectric constant, Dk_{L1}, ranges from 1.0 to 2.7, and the second dielectric constant, Dk_{L2}, ranges from 2.5 to 5.10.

In addition to one or more of the features described above, or as an alternative to any of the foregoing embodiments, the at least one sidewall includes a plurality of sidewalls, each of the sidewalls and the gradient lens extends along an X-axis to define a length, a Y-axis to define a width, and a Z-axis to define a thickness

In addition to one or more of the features described above, or as an alternative to any of the foregoing embodiments, the first dielectric constant, Dk_{L1}, is 2.5; the second dielectric constant, Dk_{L2}, is 2.9; the length is 6.15 inches (156.21 mm); the width is 6.15 inches (156.21 mm); and the thickness is 1.97 inches (50.038 mm).

In addition to one or more of the features described above, or as an alternative to any of the foregoing embodiments, the first dielectric constant, Dk_{L1}, is 1.50; the second dielectric constant, Dk_{L2}, is 5.07; the length is 4.6 inches (116.84 mm); the width is 6.15 inches (116.84 mm); and the thickness is 1.22 inches (30.988 mm).

In addition to one or more of the features described above, or as an alternative to any of the foregoing embodiments, the sidewalls extend inward toward the inner cavity to define a tapered profile.

In addition to one or more of the features described above, or as an alternative to any of the foregoing embodiments, the sidewalls taper inward at an draft angle ranging from 20 degrees to 30 degrees.

In addition to one or more of the features described above, or as an alternative to any of the foregoing embodiments, the gradient lens includes an intermediate lens region with one or more dielectric constant values, Dk_{LX}, that gradually decrease from the second lens portion having Dk_{L2} to the first lens portion having Dk_{L1}.

In addition to one or more of the features described above, or as an alternative to any of the foregoing embodiments, the dielectric cover comprises: a base having a circular profile defined by a first diameter; and a circular sidewall extending orthogonally from the base and defining an inner cavity configured to receive the patch antenna, wherein the gradient lens is disposed on an upper surface of the circular sidewall and has a circular profile defined by a second diameter.

In addition to one or more of the features described above, or as an alternative to any of the foregoing embodiments, the second dielectric constant, Dk_{L1} is 2.59; the first diameter is 12 inches (304.8 mm); and the second diameter is 9 inches (228.6 mm).

### BRIEF DESCRIPTION OF THE DRAWINGS

Referring to the exemplary non-limiting drawings wherein like elements are numbered or illustrated alike in the accompanying Figures:

FIG. 1A is trimetric view of an antenna assembly according to a non-limiting embodiment of the present disclosure;

FIG. 1B is a front view of the antenna assembly shown in FIG. 1B according to a non-limiting embodiment of the present disclosure;

FIG. 2 depicts an assembled view of a patch antenna included in the antenna assembly shown in FIGS. 1A and 1B according to a non-limiting embodiment of the present disclosure;

FIG. 3 depicts a first substrate included in the patch antenna shown in FIG. 2 according to a non-limiting embodiment of the present disclosure;

FIG. 4 depicts a magnetodielectric material (MDM) substrate included in the patch antenna shown in FIG. 2 according to a non-limiting embodiment of the present disclosure;

FIG. 5A is a trimetric view of the antenna assembly shown in FIGS. 1A and 1B according to a non-limiting embodiment of the present disclosure;

FIG. 5B is a front view of the antenna assembly shown in FIGS. 5A according to a non-limiting embodiment of the present disclosure;

FIG. 6A is a diagram depicting a phase component of an electric field vector (E) in the y-direction (Phase Ey) produced by the patch antenna shown in FIG. 2 excluding the parse gradient dielectric cover;

FIG. 6B is a diagram depicting a phase component of Phase Ey produced by the patch antenna shown in FIG. 2 including the parse gradient dielectric cover;

FIG. 7A is a diagram depicting a magnitude component of an electric field vector E in the y-direction (Magnitude Ey) produced by the patch antenna shown in FIG. 2 excluding the parse gradient dielectric cover utilizing air dielectric (Dk=1) while excluding a separate dielectric slab;

FIG. 7B is a diagram depicting a magnitude component of the Magnitude Ey produced by the patch antenna shown in FIG. 2 including the parse gradient dielectric cover utilizing air dielectric (Dk=1) in combination with a separate dielectric slab;

FIG. 8A is a diagram depicting the Magnitude Ey produced by the patch antenna shown in FIG. 2 that utilizes a gradient lens that excludes sidewalls;

FIG. 8B is a diagram depicting the Magnitude Ey produced by the patch antenna shown in FIG. 2 that utilizes a gradient lens that includes the sidewalls;

FIG. 9 is a diagram comparing the reflection coefficient of the antenna assembly shown in FIGS. 5A and 5B including (i.e., with) the parse gradient dielectric cover compared to the antenna assembly excluding (i.e., without (WO) the parse gradient dielectric cover;

FIG. 10 depicts is a diagram comparing the realized gain for right hand circular polarization (RHCP) of the antenna assembly shown in FIGS. 5A and 5B including the parse gradient dielectric cover at frequencies ranging from 1.5 GHz to 1.6 GHz compared to the antenna assembly shown in FIGS. 5A and 5B excluding the parse gradient dielectric cover at frequencies ranging from 1.5 GHz to 1.6 GHz;

FIG. 11 depicts is a diagram comparing the realized gain for right hand circular polarization (RHCP) of the antenna assembly shown in FIGS. 5A and 5B including the parse gradient dielectric cover at frequencies ranging from 1.62 GHz to 1.7 GHz compared to the antenna assembly shown in FIGS. 5A and 5B excluding the parse gradient dielectric cover at frequencies ranging from 1.62 GHz to 1.7 GHz;

FIG. 12 is a diagram comparing the axial ratio (dB) Vs. theta (deg) of the antenna assembly shown in FIGS. 5A and 5B including the parse gradient dielectric cover compared to antenna assembly shown in FIGS. 5A and 5B excluding the parse gradient dielectric cover;

FIG. 13 is a diagram comparing the axial ratio (dB) Vs. Frequency (GHz) of the antenna assembly shown in FIGS. 5A and 5B including the parse gradient dielectric cover compared to the antenna assembly shown in FIGS. 5A and 5B excluding the parse gradient dielectric cover;

FIG. 14 is a diagram comparing the right hand circular polarization (RHCP) Vs. left hand circular polarization (LHCP) of the antenna assembly shown in FIGS. 5A and 5B including the parse gradient dielectric cover at frequencies ranging from 1.5 GHz to 1.6 GHz compared to the antenna assembly shown in FIGS. 5A and 5B excluding the parse gradient dielectric cover at frequencies ranging from 1.5 GHz to 1.6 GHz;

FIG. 15 is a diagram comparing the RHCP Vs. LHCP of the antenna assembly shown in FIGS. 5A and 5B including the parse gradient dielectric cover at frequencies ranging from 1.62 GHz to 1.7 GHz compared to the antenna assembly shown in FIGS. 5A and 5B excluding the parse gradient dielectric cover at frequencies ranging from 1.62 GHz to 1.7 GHz

FIG. 16 is a diagram comparing the efficiency of the antenna assembly shown in FIGS. 5A and 5B including the parse gradient dielectric cover compared to the antenna assembly shown in FIGS. 5A and 5B excluding the parse gradient dielectric cover;

FIG. 17A is a trimetric view depicting a antenna assembly according to another non-limiting embodiment of the present disclosure;

FIG. 17B is a cross-sectional view of the antenna assembly shown in FIG. 17A taken along line 17-17;

FIG. 18 is a trimetric depicting a patch antenna included in the antenna assembly shown in FIG. 17A according to another non-limiting embodiment of the present disclosure;

FIG. 19 is a diagram comparing the reflection coefficient of the patch antenna shown in FIG. 18 including a parse gradient dielectric cover compared to the patch antenna excluding the parse gradient dielectric cover;

FIG. 20 depicts is a diagram comparing the realized gain for RHCP of the patch antenna shown in FIG. 18 including a parse gradient dielectric cover at frequencies ranging from 1.5 GHz to 1.7 GHz with a horizontal angular direction set at 90 degrees compared to the patch antenna shown excluding the parse gradient dielectric cover at frequencies ranging from 1.5 GHz to 1.7 GHz with a horizontal angular direction set at 90 degrees;

FIG. 21 is a diagram comparing the realized gain for RHCP of the patch antenna 150 including the parse gradient dielectric cover shown in FIG. 18 at frequencies ranging from 1.5 GHz to 1.7 GHz with a horizontal angular direction set at 0 degrees compared to the patch antenna excluding the parse gradient dielectric cover at frequencies ranging from 1.5 GHz to 1.7 GHz with a horizontal angular direction set at 0 degrees;

FIG. 22 is a diagram comparing the axial ratio (dB) Vs. theta (deg) of the patch antenna shown in FIG. 18 including a parse gradient dielectric cover compared to the patch antenna excluding the parse gradient dielectric cover;

FIG. 23 is a diagram comparing the RHCP Vs. LHCP of the patch antenna shown in FIG. 18 including the parse gradient dielectric cover at a frequency of 1.5 GHz and a horizontal angular direction ranging from 0 degrees to 160 degrees compared to the patch antenna excluding the parse gradient dielectric cover at a frequency set at 1.5 GHz and a horizontal angular direction (e.g., e.g., azimuth or boresight direction) ranging from 0 degrees to 160 degrees

FIG. 24A is a trimetric view depicting an antenna assembly according to a non-limiting embodiment of the present disclosure;

FIG. 24B is a trimetric view depicting a patch antenna implemented in the antenna assembly shown in FIG. 24A;

FIG. 25 is a diagram comparing the reflection coefficient of the patch antenna shown in FIGS. 24A and 24B including the parse gradient dielectric cover compared to the patch antenna shown in FIGS. 24A and 24B excluding the parse gradient dielectric cover;

FIG. 26 is a diagram comparing the realized gain for RHCP of the patch antenna shown in FIGS. 24A and 24B including the parse gradient dielectric cover at frequencies ranging from 1.5 GHz to 1.6 GHz compared to the patch antenna shown in FIGS. 24A and 24B excluding the parse gradient dielectric cover at frequencies ranging from 1.5 GHz to 1.6 GHz;

FIG. 27 is a diagram comparing the realized gain for RHCP of the patch antenna shown in FIGS. 24A and 24B including the parse gradient dielectric cover at frequencies ranging from 1.5 GHz to 1.6 GHz to the patch antenna shown in FIGS. 24A and 24B excluding the parse gradient dielectric cover at frequencies ranging from 1.5 GHz to 1.6 GHz;

FIG. 28 is a diagram comparing the axial ratio (dB) Vs. theta (deg) of the patch antenna shown in FIGS. 24A and 24B including the parse gradient dielectric cover to the patch antenna excluding the parse gradient dielectric cover;

FIG. 29 is a diagram comparing the RHCP Vs. LHCP of the patch antenna shown in FIGS. 24A and 24B including the parse gradient dielectric cover at frequencies ranging from 1.5 GHz to 1.6 GHz to the patch antenna shown in FIGS. 24A and 24B excluding the parse gradient dielectric cover at frequencies ranging from 1.5 GHz to 1.6 GHz;

FIG. 30 is a diagram comparing the RHCP Vs. LHCP of the patch antenna shown in FIGS. 24A and 24B including the parse gradient dielectric cover at frequencies ranging from 1.62 GHz to 1.7 GHz compared to the patch antenna shown in FIGS. 24A and 24B excluding the parse gradient dielectric cover at frequencies ranging from 1.62 GHz to 1.7 GHz;

FIG. 31 depicts a parse gradient dielectric cover that can be utilized with the patch antenna shown in FIG. 24B to establish an antenna assembly according to another non-limiting embodiment of the present disclosure;

FIG. 32 is a diagram comparing the reflection coefficient of the patch antenna shown in FIG. 24B including the parse gradient dielectric cover shown in FIG. 31 compared to the patch antenna excluding the parse gradient dielectric cover shown in FIG. 31;

FIG. 33 is a diagram comparing the axial ratio (dB) Vs. theta (deg) of the patch antenna shown in FIG. 24B including the parse gradient dielectric cover shown in FIG. 31 compared to the patch antenna excluding the parse gradient dielectric cover shown in FIG. 31;

FIG. 34 is a diagram comparing the RHCP Vs. LHCP of the patch antenna shown in FIG. 24B including the parse gradient dielectric cover shown in FIG. 31 at frequencies ranging from 1.5 GHz to 1.6 GHz compared to the patch antenna shown in FIG. 24B excluding the parse gradient dielectric cover shown in FIG. 31 at frequencies ranging from 1.5 GHz to 1.6 GHz; and

FIG. 35 is a diagram comparing the RHCP Vs. LHCP of the patch antenna shown in FIG. 24B including the parse gradient dielectric cover shown in FIG. 31 at frequencies ranging from 1.62 GHz to 1.7 GHz compared to the patch antenna shown in FIG. 24B excluding the parse gradient dielectric cover shown in FIG. 31 at frequencies ranging from 1.62 GHz to 1.7 GHz.

One skilled in the art will understand that the drawings, further described herein below, are for illustration purposes only. It will be appreciated that for simplicity and clarity of illustration, elements shown in the figures have not necessarily been drawn to scale. For example, the dimensions or scale of some of the elements may be exaggerated relative to other elements for clarity. Further, where considered appropriate, reference numerals may be repeated among the figures to indicate corresponding or analogous elements, or analogous elements may not be repetitively enumerated in all figures where it will be appreciated and understood that such enumeration where absent is inherently disclosed.

### DETAILED DESCRIPTION

The following examples are provided to illustrate the present disclosure. The examples are merely illustrative and are not intended to limit devices made in accordance with the disclosure to the materials, conditions, or process parameters set forth therein.

As used herein, the phrase “embodiment” means “embodiment disclosed and/or illustrated herein”, which may not necessarily encompass a specific embodiment of an invention in accordance with the appended claims, but nonetheless is provided herein as being useful for a complete understanding of an invention in accordance with the appended claims.

Although the following detailed description contains many specifics for the purposes of illustration, anyone of ordinary skill in the art will appreciate that many variations and alterations to the following details are within the scope of the appended claims. For example, where described features may not be mutually exclusive of and with respect to other described features, such combinations of non-mutually exclusive features are considered to be inherently disclosed herein. Additionally, common features may be commonly illustrated in the various figures but may not be specifically enumerated in all figures for simplicity, but would be recognized by one skilled in the art as being an explicitly disclosed feature even though it may not be enumerated in a particular figure. Accordingly, the following example embodiments are set forth without any loss of generality to, and without imposing limitations upon, the claimed invention disclosed herein.

Various non-limiting embodiments described herein provide a compact antenna assembly that improves a wider-field of view (FOV) and facilitates improved usage in various L-band frequencies and Inmarsat Band frequencies ranging for example, from approximately 1.5 GHz to 1.7 GHz. The antenna assembly includes a patch antenna such as a patch antenna, for example, which employs a stacked substrate with a stacked arrangement of substrates having various dielectric constants (Dk). As described herein, ‘Dk’ refers to the dielectric constant of a material, but it should be appreciated that the dielectric constant is also sometimes interchangeably referred to as dielectric permittivity ‘ε’ or relative permittivity ‘εr’. At least one of the substrates included in the stacked substrate includes a magneto-dielectric material (MDM) in combination to establish a MDM based radiator, which generates wide impedance bandwidth, axial ratio and can be used as a source. The cross-dipole can be fed with the equal magnitude and phase quadrature to generate pure circular polarization which makes the axial ratio.

Various non-limiting embodiments utilize the cross-dipole antenna to provide a compact antenna assembly that employs a sparse gradient dielectric cover in addition to the combination with MDM based radiator, which provides a further FOV enhancement. For instance, the sparse gradient dielectric cover produces a wide beamwidth coverage that meets horizon angles, e.g., + or −80 degrees, compared to the narrow beamwidths provided by conventional bulky single radiator GPS antennas. As described herein, the term “gradient” refers to a cover and/or a lens of the cover having at least two lens portions with different dielectric constants. In some embodiments, the term gradient refers to a cover and/or a lens having at least two lens portions that provide different effective dielectric constant observed by the electric field produced by the patch antenna.

According to one or more non-limiting embodiments, the magnetodielectric material can include a hexagonal ferrite particles and polytetrafluoroethylene (PTFE) or polyphenylene sulfide (PPS) polymer. The hexagonal ferrite material can include Z-type (Co2Z), or Y-type (Co2Y) hexaferrite. In an embodiment, the magnetodielectric composite can comprise 10-80 volume percent (vol %), of a magnetic filler (ferrite or metallic particle), and 20-90 vol % of a polymer, based on a total weight of the magnetodielectric composite.

The technical application herein mentioned can be applied, for example, to Inmarsat Band and GPS applications. For example, the compact antenna assembly can operate in a frequency range of approximately 1.5 GHz to approximately 1.7 GHz, including: from 1.518 GHz to 1.559 GHz; from 1.626 GHz to 1.660.5 GHz; and from 1.668 GHz to 1.675 GHz. In at least one non-limiting embodiment, the compact antenna assembly according to the inventive teachings described herein can operate in the entire L-band frequency range.

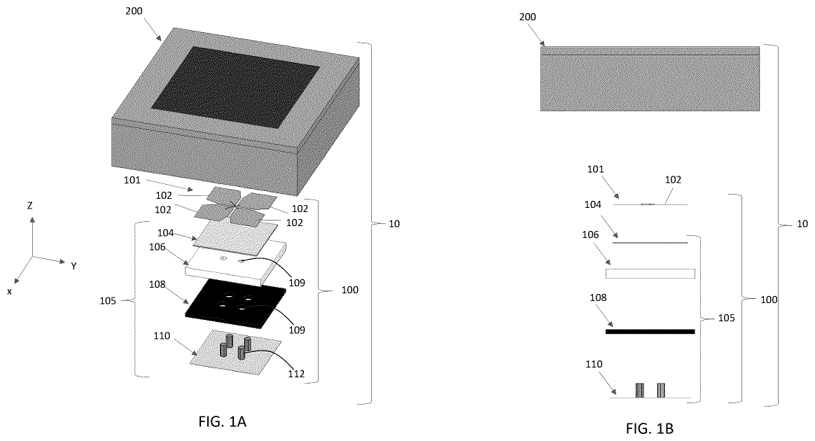

With reference now to FIGS. 1A and 1B, an antenna assembly 10 is illustrated according to a non-limiting embodiment of the present disclosure. The antenna assembly 10 includes a patch antenna 100 and a parse gradient dielectric cover 200. The patch antenna 100 includes electromagnetic (EM) radiating elements 102, a first substrate 104, a second substrate 106, a third substrate 108, and a ground plane 110. The combination of the first substrate 104, the second substrate 106, the third substrate 108, and the ground plane 110 are stacked on top of one another to form a substrate stack 105. The radiating elements 102 can have various profiles including, but not limited to, square-shaped, rectangular-shaped, and circular shaped. Likewise, the first substrate 104, the second substrate 106, the third substrate 108, and the ground plane 110 can have various profiles including, but not limited to, square-shaped, rectangular-shaped, and circular shaped.

As described herein, the antenna assembly 10 is capable of achieving a wide FOV i.e., + or −80 degrees, or greater, with the single radiator by implementing a stack of dielectric substrates and a substrate comprising a magnetodielectric (MGM) material. The aforementioned substrate stack improves the wider impedance bandwidth, axial ratio and gain performances, thereby allowing the antenna assembly 10 to utilize a single radiating element that achieves a wide FOV coverage above angles of Horizon (+ or −80 degrees).

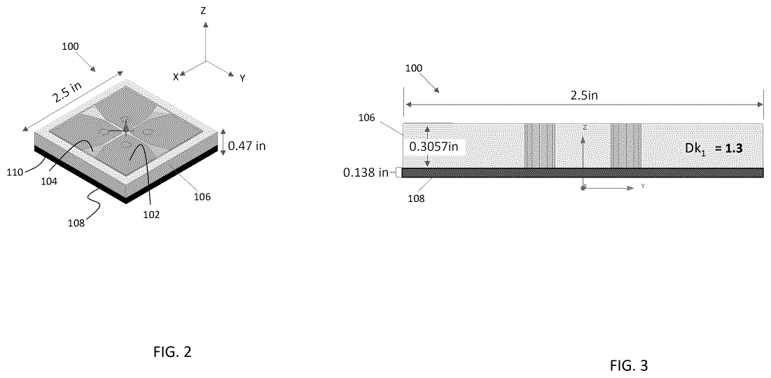

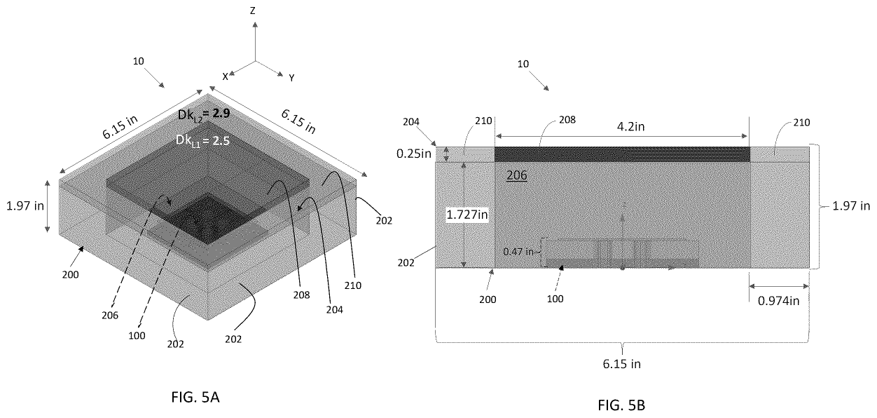

With continued reference to FIGS. 1A and 1B, along with FIGS. 2, 3, 4, 5A and 5B, the patch antenna 100 is described in greater detail. The radiating elements 102 comprise an electrically conductive material, which is formed on a first substrate 104 comprising a dielectric material. The electrically conductive material of the radiating elements 102 includes various metals such as, for example, copper (Cu).

FIG. 2 illustrates an assembled view of the patch antenna 100. According to a non-limiting embodiment, the radiating elements 102 are shown formed on the first substrate 104 and arranged as orthogonal patch dipole radiating elements (also referred to herein as patch dipoles) to establish a cross-dipole configuration 101, referred to herein as a cross-dipole 101. The size of each patch dipole radiating element 102 can be designed according to a target operating frequency of the patch antenna 100. According to a non-limiting embodiment, each patch dipole radiating element 102 is approximately half the wavelength of the center frequency in the first substrate's medium, considering the effect of the first substrates dielectric constant. This arrangement allows the patch antenna 100 to radiate or receive circularly polarized waves, which is advantageous in reducing signal degradation due to multipath fading in mobile environments. In addition, the ability to provide circular polarization makes the patch antenna 100 suitable for applications where the orientation of the transmitter or receiver varies, such as in mobile satellite communications.

With continued reference to FIG. 2, the first substrate 104, upon which the metal patch dipoles 102 are formed, is referred to as a “low-loss substrate 104” and is formed from various low-loss materials having a dielectric constant (Dk₁) ranging, for example, from about 2.9 to about 3.1, with a preferred Dk₁ of 3.0. The first substrate 104 also has a thickness ranging, for example, from about 0.02 inches (0.508 millimeters (mm)) to about 0.05 inches (1.27 mm), and in some embodiments has a thickness of 0.03 inches (0.762 mm). The Dk₁ of the first substrate 104 determines a velocity of the electromagnetic wave propagating through the first substrate 104, and thus controls the resonant frequency of the patch antenna 100. The thickness and dielectric constant (Dk₁) of the first substrate 104 also influence the impedance bandwidth and radiation efficiency of patch antenna 100. By adjusting these parameters, the patch antenna 100 can be optimized to operate according to specific performance requirements such as bandwidth, gain, and size.

The second substrate 106 on which the first substrate 104 is disposed is formed from various dielectric materials having a Dk₂ ranging from 1.0 to 1.4, with a preferred Dk₂ of 1.3. The second substrate 106 has a thickness (e.g., along the Z-axis) ranging, for example, from about 0.3050 inches (7.747 mm) to about 0.3060 inches (7.7724 mm), with a thickness preferable set at 0.3057 inches (7.76478 mm), a length (e.g. along the Y-axis) ranging from, for example, from about 2.0 inches (50.8 mm) to about 3.0 inches (76.2 mm), with a length preferably set at 2.5 inches (63.5 mm), and a width (e.g. along the X-axis) ranging, for example, from about 2.0 inches (50.8 mm) to about 3.0 inches (76.2 mm), with a width preferably set at 2.5 inches (63.5 mm).

The stacked combination of the first substrate 104 and the second substrate 106 can enhance the bandwidth of the patch antenna 100, while the contrasting dielectric constants of the two substrates 104 and 106 can facilitate a broader impedance bandwidth. The contrasting dielectric constants also allow for a certain degree of freedom in controlling the overall thickness of the patch antenna 100, which is particularly useful when aiming to manufacture a cross-dipole antenna having a low-profile antenna without compromising performance.

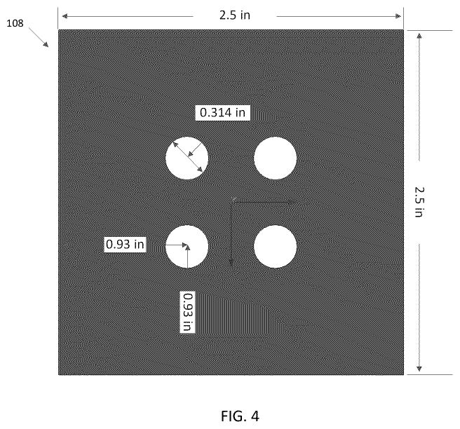

With continued reference to FIGS. 2 to and 3 along with FIG. 4, the third substrate 108 on which the second substrate 106 is disposed has a thickness ranging, for example, from about 0.135 inches (3.429 mm) to about 0.140 inches (3.556 mm), with a thickness preferably set at 0.318 inches (8.0772 mm), a length (e.g. along the Y-axis) ranging from, for example, from about 2.0 inches (50.8 mm) to about 3.0 inches (76.2 mm), with a length preferably set at 2.5 inches (63.5 mm), and a width (e.g. along the X-axis) ranging, for example, from about 2.0 inches (50.8 mm) to about 3.0 inches (76.2 mm), with a width preferably set at 2.5 inches (63.5 mm). The third substrate 108, referred to herein as a magnetodielectric substrate 108, comprises a magnetodielectric material (MDM), which can include hexagonal ferrite particles and PTFE or PPS polymer. The hexagonal ferrite material can include Z-type (Co2Z), or Y-type (Co2Y) hexaferrite. The MDM has a dielectric constant (Dk₃) ranging from 11.90 to 12.05, with a Dk₃ preferably of 11.98, and has permeability (μ) ranging from about 6.50 and 7.60, with a preferred permeability (μ) of 6.55.

The third substrate 108 (i.e., the magnetodielectric substrate) is disposed directly on the ground plane 110. The ground plane 110 is formed from various electrically conductive materials such as, for example, metal. The ground plane 110 provides a necessary reference plane for the patch dipole elements 102, and can serve as a reflector to enhance radiation in a targeted direction. According to a non-limiting embodiment, the ground plane 110 can include one or more metal posts 112, which can be disposed through one or more holes 109 formed in the third substrate 108 and the second substrate 106 to stabilize the stacked substrate layers of the patch antenna 100. According to a non-limiting embodiment, the holes 109 can be arranged from about 0.90 inches (22.86 mm) to about 0.95 (24.13 mm), and preferably 0.93 inches (23.622 mm), from the sides of the third substrate 108 and the second substrate 106, and can have a diameter ranging, for example, from about 0.310 inches (7.874 mm) to about 0.320 inches (8.128 mm), with a preferred diameter set at 0.314 inches (7.9756 mm). Although the holes 109 are described as having a circular profile, it should be appreciated that any profile capable of receiving the metal posts can be utilized without departing from the scope of the present disclosure.

With continued reference to FIGS. 1A, 1B along with 5A and 5B, the parse gradient dielectric cover 200 is illustrated in greater detail. The parse gradient dielectric cover 200 includes sidewalls 202 and a gradient lens 204. According to a non-limiting embodiment, the cover 200 has a total thickness (e.g., along the Z-axis) ranging, for example, from about 1.90 inches (48.26 mm) to about 2.0 inches (50.8 mm), with a total thickness preferable set at 1.97 inches (50.038 mm), a total length (e.g. along the Y-axis) ranging from, for example, from about 6.10 inches (154.94 mm) to about 6.20 inches (157.48 mm), with a total length preferably set at 6.15 inches (156.21 mm), and a total width (e.g. along the X-axis) ranging, for example, from about 6.0 inches (152.4 mm) to about 6.20 inches (157.48 mm), with a total width preferably set at 6.15 inches (156.21 mm).

The sidewalls 202 extend orthogonally from the gradient lens 204 and define an inner cavity 206 configured to receive the patch antenna 100. The sidewalls 202 extend from a bottom end to a top end (e.g., along the Z-axis) to define a sidewall height. Each sidewall 202 has a thickness ranging, for example, from about 1.720 inches (43.688 mm) to about 1.730 inches (43.942 mm), with a thickness preferable set at 1.727 inches (43.8658 mm), a length (e.g. along the Y-axis) ranging from, for example, from about 6.10 inches (154.94 mm) to about 6.20 inches (157.48 mm), with a total length preferably set at 6.15 inches (156.21 mm), and a total width (e.g. along the X-axis) ranging, for example, from about 6.0 inches (152.4 mm) to about 6.20 inches (157.48 mm), with a total width preferably set at 6.15 inches (156.21 mm). The sidewalls 202 are formed from a dielectric material having a dielectric constant ranging, for example, from Dk=1.0 to Dk=5.5. In at least one embodiment, the sidewalls 202 have a Dk=2.9. Accordingly, the dielectric sidewalls 202 reduce, or even completely prevent, reflection back to the source and reduces the narrow impedance bandwidth behavior to the source such that the electric fields produced by the patch antenna 100 are refracted through the dielectric material.

The gradient lens 204 is disposed on the sidewalls 202 (e.g., the top ends of the sidewalls) to completely cover the patch antenna 100 disposed in the cavity 206. The lens 204 has a thickness (e.g., along the Z-axis) ranging, for example, from about 0.20 inches (5.08 mm) to about 0.30 (7.62 mm), with a thickness preferable set at 0.25 inches (6.35 mm), a length (e.g. along the Y-axis) ranging from, for example, from about 6.10 inches (154.94 mm) to about 6.20 inches (157.48 mm), with a total length preferably set at 6.15 inches (156.21 mm), and a total width (e.g. along the X-axis) ranging, for example, from about 6.0 inches (152.4 mm) to about 6.20 inches (157.48 mm), with a total width preferably set at 6.15 inches (156.21 mm).

The lens 204 establishes a gradient dielectric constant (Dk) using two or more gradient lens portions having different dielectric constants. According to a non-limiting embodiment, the lens 204 includes a first lens portion 208 and a second lens portion 210 that surrounds the first lens portion 208. According to a non-limiting embodiment, the first lens portion 208 has a first dielectric constant, Dk_{L1}, and the second lens portion 210 has a second dielectric constant, Dk_{L2}, that is greater than Dk_{L1}. In some embodiments, the first lens portion 208 has a Dk_{L1} ranging, for example, from about 1.0 to about 2.7. In some embodiments, the first lens portion 208 has a Dk_{L1} ranging, for example, from about 2.3 to about 2.6, with a preferred Dk_{L1} of 2.5. In one or more non-limiting embodiments, the first lens portion 208 with Dk_{L1} extends from the center of the lens 204 until reaching the second lens portion 210, and has a length ranging, for example, from about 4.0 inches (101.6 mm) to about 4.5 inches (114.3 mm), and preferably, 4.2 inches (106.68 mm).

The second lens portion 210 extends from the first portion 208 until reaching the ends of the lens 204. The second lens portion 210 has a Dk_{L2} ranging, for example, from about 2.5 to about 5.10. In some embodiments, the second lens portion 210 has a Dk_{L2} ranging, for example, from about 2.7 to about 3.0, with a preferred Dk_{L2} of 2.9. In one or more non-limiting embodiments, the second lens portion 210 extends from the first lens portion 208 to the lens ends at a distance ranging, for example, from about 0.97 inches (24.638 mm) to about 0.98 inches (24.892 mm), and preferably, 0.974 inches (24.7396 mm).

Although the example gradient lens 204 is described as having two discrete dielectric constant values (e.g., Dk_{L1}=2.9 and Dk_{L2}=2.5), it should be appreciated that gradient lens 204 can have a gradient dielectric constant that constantly varies from a larger dielectric constant value at the ends of lens 204 down to a smaller dielectric constant value at the middle of the lens 204. For example, the gradient lens 204 can have a dielectric constant value Dk_{L1}=2.9 at the at the ends of lens 204 and a dielectric constant value Dk_{L2}=2.5 at the middle of the lens 204, with dielectric constant values Dk_{LX} varying from 2.89 down to 2.51 therebetween.

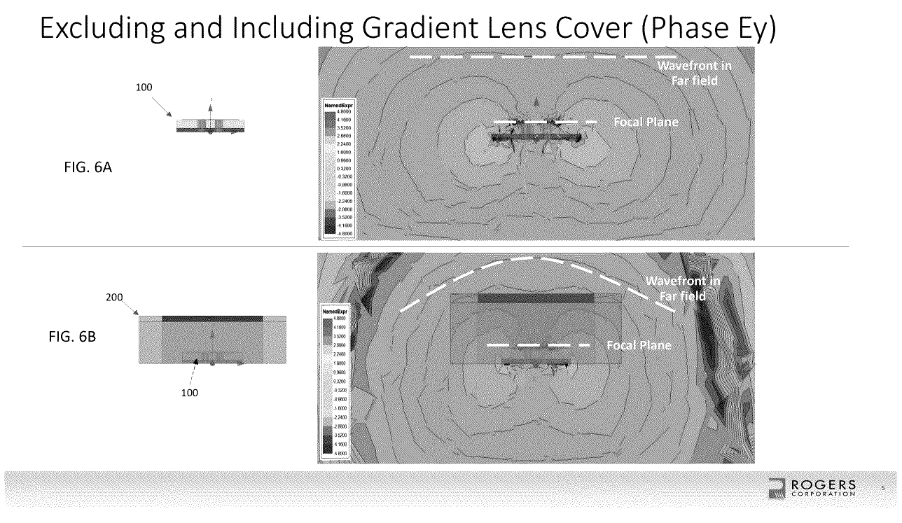

Referring now to FIG. 6A, a diagram depicts the phase component of an electric field vector (E) in the y-direction (referred to as Phase Ey) produced by the patch antenna 100 excluding the parse gradient dielectric cover 200. As shown, the wavefront in the far FOV is about 0 degrees. According to a non-limiting embodiment, the far FOV can include magnitudes and phase at a distance of 46 mm or greater.

Turning to FIG. 6B, a diagram depicts the phase component of Phase Ey produced by the patch antenna 100 that includes the parse gradient dielectric cover 200. As shown, bending of the wavefront in the far FOV is increased thereby providing improved Horizon coverage compared to the coverage provided when the parse gradient dielectric cover 200 is excluded.

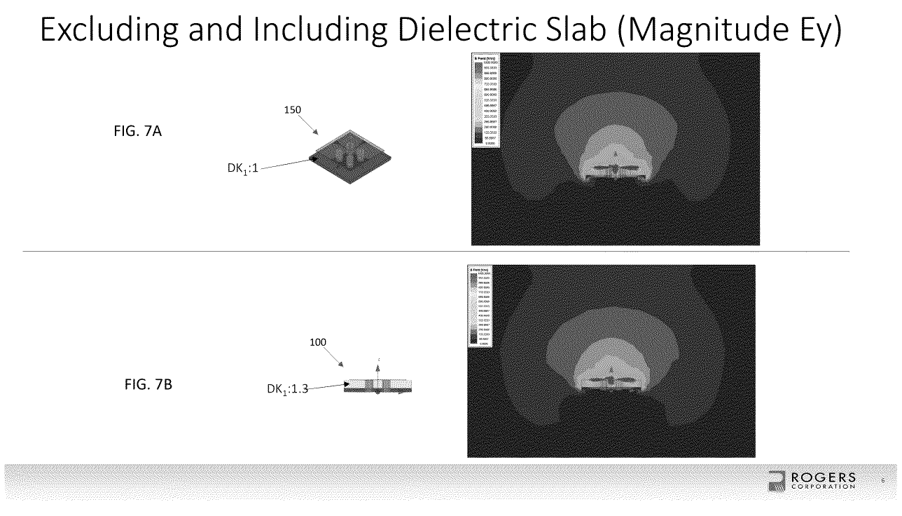

Referring now to FIG. 7A, a diagram depicts the magnitude component of an electric field vector E in the y-direction (referred to as Magnitude Ey) produced by the patch antenna 150 utilizing an air dielectric (Dk=1) while excluding a dielectric slab, e.g., dielectric substrate 106.

Turning to FIG. 7B, a diagram depicts the Magnitude Ey produced by the patch antenna 100 utilizing air along with a dielectric slab, e.g., dielectric substrate 106, to increase the overall dielectric constant to Dk=1.3.

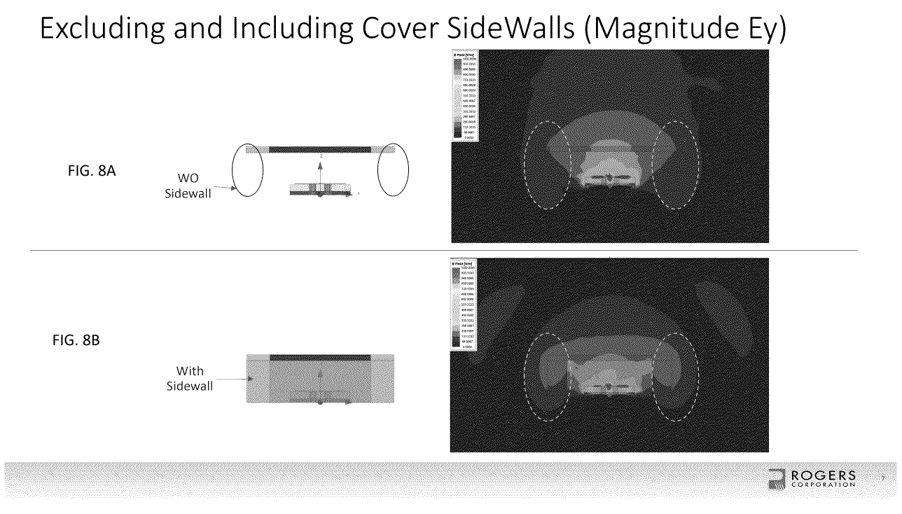

Referring to FIG. 8A, a diagram depicts the Magnitude Ey produced by the patch antenna 100 that implements the gradient lens 204 while excluding the cover sidewalls 202. As shown, energy is allowed to reflect back to the source, thereby increasing the narrow impedance bandwidth behavior to the source that causes a narrower FOV.

Turning to FIG. 8B, a diagram depicts the Magnitude Ey produced by the patch antenna 100 that implements the parse gradient dielectric cover 200 including both the gradient lens 204 and the dielectric cover sidewalls 202. As shown, the sidewalls 202 reduce, or even completely prevent, reflection back to the source, thereby reducing the narrow impedance bandwidth behavior to the source such that the electric fields produced by the patch antenna 100 are refracted through the dielectric material. Accordingly, magnitude taper on the boresight direction is reduced while phase bending along the Horizon is increased to achieve coverage of + or −80 degrees.

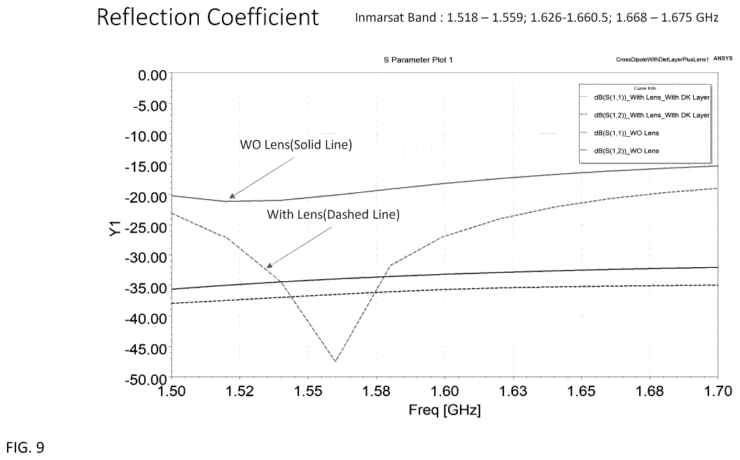

FIGS. 9 through 16 are diagrams depicting various performance characteristics of the patch antenna 100 including the parse gradient dielectric cover 200 compared to the patch antenna 100 excluding the parse gradient dielectric cover 200.

FIG. 9 compares the reflection coefficient of the patch antenna 100 including the parse gradient dielectric cover 200 compared to the patch antenna 100 excluding the parse gradient dielectric cover 200.

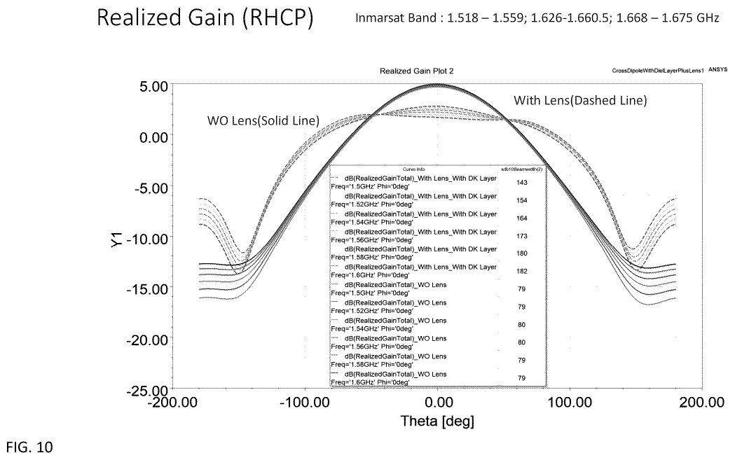

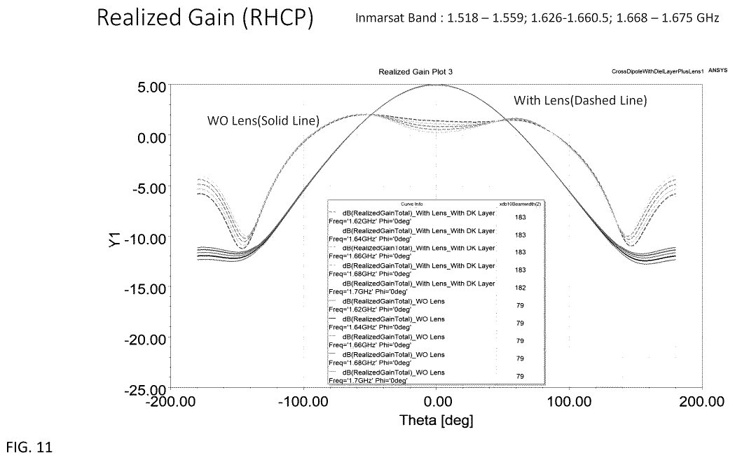

FIG. 10 compares the realized gain for right hand circular polarization (RHCP) of the patch antenna 100 including the parse gradient dielectric cover 200 at frequencies ranging from 1.5 GHz to 1.6 GHz compared to the patch antenna 100 excluding the parse gradient dielectric cover 200 at frequencies ranging from 1.5 GHz to 1.6 GHz.

FIG. 11 compares the realized gain for right hand circular polarization (RHCP) of the patch antenna 100 including the parse gradient dielectric cover 200 at frequencies ranging from 1.62 GHz to 1.7 GHz compared to the patch antenna 100 excluding the parse gradient dielectric cover 200 at frequencies ranging from 1.62 GHz to 1.7 GHz.

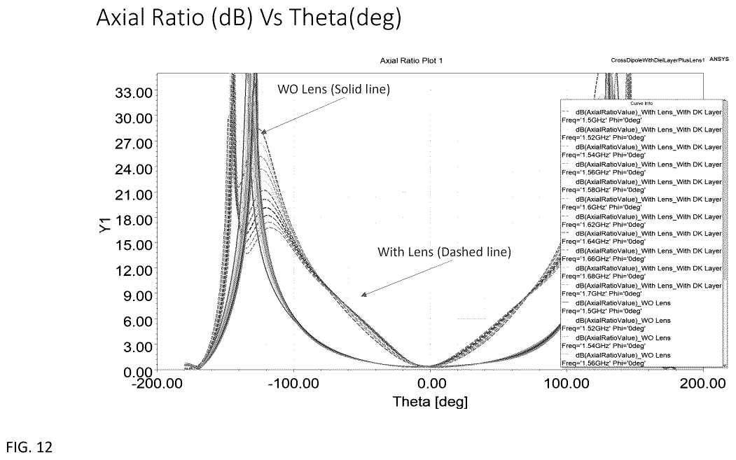

FIG. 12 compares the axial ratio (dB) Vs. theta (deg) of the patch antenna 100 including the parse gradient dielectric cover 200 compared to the patch antenna 100 excluding the parse gradient dielectric cover 200.

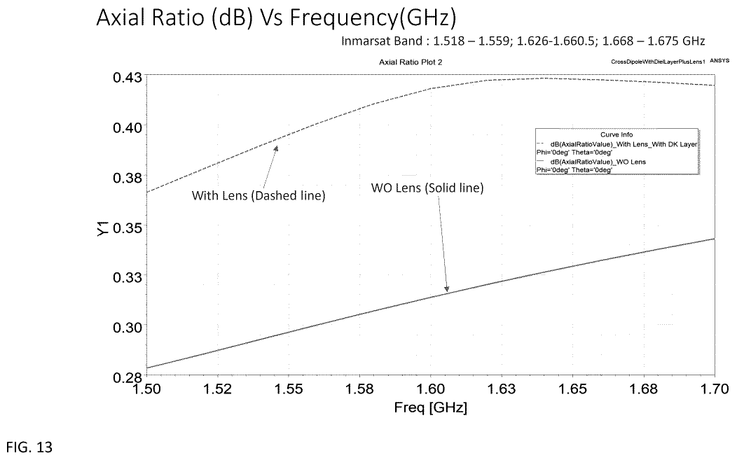

FIG. 13 compares the axial ratio (dB) Vs. Frequency (GHz) of the patch antenna 100 including the parse gradient dielectric cover 200 compared to the patch antenna 100 excluding the parse gradient dielectric cover 200.

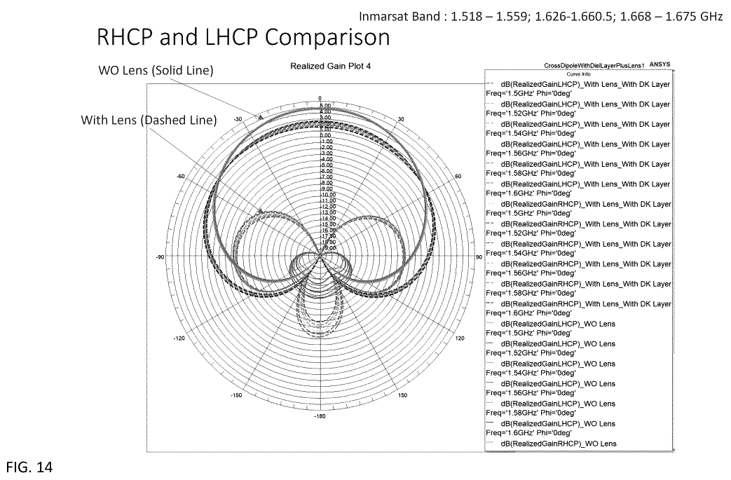

FIG. 14 compares the right hand circular polarization (RHCP) Vs. left hand circular polarization (LHCP) of the patch antenna 100 including the parse gradient dielectric cover 200 at frequencies ranging from 1.5 GHz to 1.6 GHz compared to the patch antenna 100 excluding the parse gradient dielectric cover 200 at frequencies ranging from 1.5 GHz to 1.6 GHz.

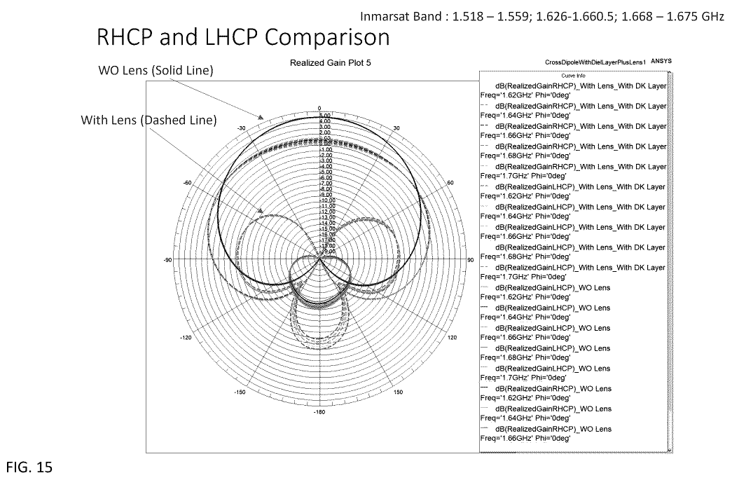

FIG. 15 compares the RHCP Vs. LHCP of the patch antenna 100 including the parse gradient dielectric cover 200 at frequencies ranging from 1.62 GHz to 1.7 GHz compared to the patch antenna 100 excluding the parse gradient dielectric cover 200 at frequencies ranging from 1.62 GHz to 1.7 GHz.

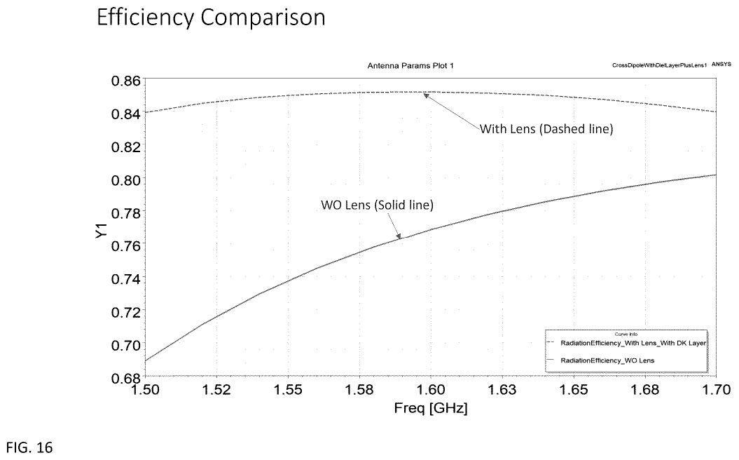

FIG. 16 compares the efficiency of the patch antenna 100 including the parse gradient dielectric cover 200 compared to the patch antenna 100 excluding the parse gradient dielectric cover 200.

Turning now to FIGS. 17A and 17B, an antenna assembly 20 is illustrated according to another non-limiting embodiment of the present disclosure. The antenna assembly 20 includes a patch antenna 150 and a dielectric cover 250.

The dielectric cover 250 includes an oval or circular lens 254 arranged above a lens base 253. Although the lens base 253 is also illustrated as having an oval or circular profile, it should be appreciated that the lens base 253 may have a different profile without departure from the scope of the present disclosure. The dielectric cover 250 further includes an oval or circular sidewall 252 extending from the lens base 253 to the lens 254. The sidewall 252 defines an inner cavity 257 configured to receive the patch antenna 150.

The dielectric cover 250 can be formed from various dielectric materials having a dielectric constant ranging from Dk=1.3 to Dk=3.0, and a Dk ranging, for example, from 2.55 to 2.60, with a preferred Dk set at 2.59. The overall diameter of the dielectric cover, e.g., established by the diameter of the lens base 253, ranges, for example, from 10 inches (254 mm) to 15 inches (381 mm), with a diameter preferably set at 12 inches (304.8 mm). The lens 254 has a lens diameter (x) ranging, for example, from 3 inches (76.2 mm) to 10 inches (177.8 mm), with a diameter preferably set at 9 inches (228.6 mm). The sidewall 252 has a height (e.g., extending along the Z-axis) ranging, for example, from 0.5 inches (12.7 mm) to 7 inches (177.8 mm), and in some embodiments has a height of 6 inches (152.4 mm).

FIG. 17B depicts a cross-sectional view of the antenna assembly 20 shown in FIG. 17A taken along line 17-17. In this example, the gradient lens 254 is established by providing at least two lens portions that provide different effective dielectric constant observed by the electric field produced by the patch antenna 150. For example, the gradient lens 254 has a first lens portion 255, and a second lens portion 256 that surrounds the first lens portion 255 and tapers away from the first lens portion 255. The first lens portion 255 provides a first effective dielectric constant (Dk_{L1}) observed by the electric field, while the second lens portion 256 provides a second effective dielectric constant (Dk_{L2}) observed by the electric field. According to a non-limiting embodiment, the first effective dielectric constant (Dk_{L1}) is set by the dielectric constant (Dk) of the material used to form the dielectric cover 250 (e.g., Dk=2.59). The tapered second lens portion 256 provides a reduced second effective dielectric constant (Dk_{L2}) of 1, for example.

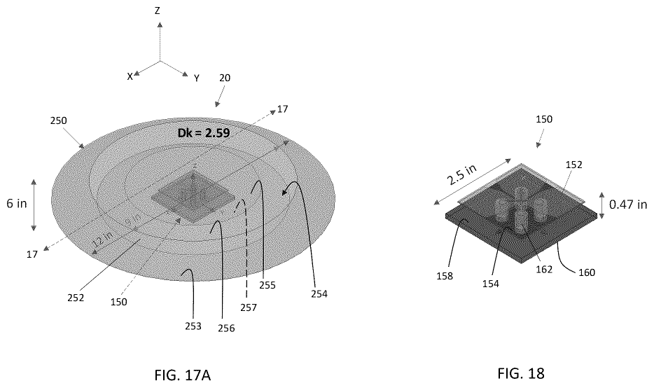

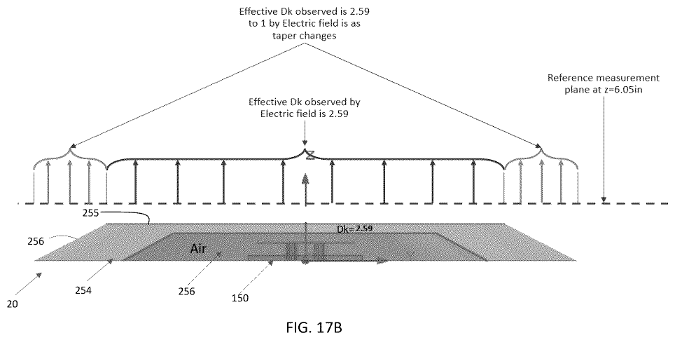

Turning to FIG. 18, the patch antenna 150 is illustrated in greater detail. The patch antenna 150 includes EM radiating elements 152, a first substrate 154, a second substrate 158, and a ground plane 160. The combination of the first substrate 154, the second substrate 158, and the ground plane 160 are vertically stacked to form a substrate stack. The radiating elements 152 can have various profiles including, but not limited to, square-shaped, rectangular-shaped, and circular shaped. Likewise, the first substrate 154, the second substrate 158, and the ground plane 160 can have various profiles including, but not limited to, square-shaped, rectangular-shaped, and circular shaped. According to a non-limiting embodiment, the first substrate 154 and the second substrate 158 are separated from one another by a layer of air having a dielectric contract of 1.0. The radiating elements 152 are formed on the first substrate 154, and comprise an electrically conductive material. The electrically conductive material of the radiating elements 152 includes various metals such as, for example, copper (Cu).

The radiating elements 152 are arranged as orthogonal patch dipole radiating elements (also referred to herein as patch dipoles) to establish a cross-dipole configuration. Although three radiating elements 152 are shown, it should be appreciated that the FIG. 18 omits one of the radiating elements 152 to more clearly show the underlying first substrate 154. The size of each patch dipole radiating element 152 can be designed according to a target operating frequency of the patch antenna 150. According to a non-limiting embodiment, each patch dipole radiating element 152 is approximately half the wavelength of the center frequency in the first substrate's medium, considering the effect of the first substrate's dielectric constant, and allows the patch antenna 150 to radiate or receive circularly polarized waves.

With continued reference to FIG. 18, the first substrate 154, upon which the metal patch dipoles 152 are formed, is formed from various dielectric materials having a dielectric constant ranging, for example, from about 1.2 to about 1.5, with a preferred dielectric constant of Dk=1.3. The first substrate 154 also has a thickness ranging, for example, from about 0.02 inches (0.508 mm) to about 0.05 inches (1.27 mm), and in some embodiments has a thickness set at 0.03 inches (0.762 mm). The first substrate 154 also has a Dk₁ ranging from about 2.9 to about 3.1, with the Dk₁ preferably set at 3.0. The Dk₁ of the first substrate 154 determines a velocity of the electromagnetic wave propagating through the first substrate, and thus controls the resonant frequency of the patch antenna 150. The thickness and Dk₁ of the first substrate 154 also influence the impedance bandwidth and radiation efficiency of the patch antenna 150. By adjusting these parameters, the patch antenna 150 can be optimized to operate according to specific performance requirements such as bandwidth, gain, and size.

The second substrate 158 on which the first substrate 154 is disposed has a thickness ranging, for example, from about 0.3050 inches (7.747 mm) to about 0.3060 inches (7.7724 mm), with a thickness preferably set at 0.3057 inches (7.76478 mm), a length (e.g. along the Y-axis) ranging from, for example, from about 2.0 inches (50.8 mm) to about 3.0 inches (76.2 mm), with a length preferably set at 2.5 inches (63.5 mm), and a width (e.g. along the X-axis) ranging, for example, from about 2.0 inches (50.8 mm) to about 3.0 inches (76.2 mm), with a width preferably set at 2.5 inches (63.5 mm). The third substrate 154 comprises a magnetodielectric material (MDM), which can include hexagonal ferrite particles and PTFE or PPS polymer. The hexagonal ferrite material can include Z-type (Co2Z), or Y-type (Co2Y) hexaferrite. The MDM has a Dk₂ ranging from about 11.50 to about 12.00, with a Dk₂ preferably set at 11.98, and has permeability (μ) ranging from about 6.00 and 7.00, with a preferred permeability (μ) set at 6.55.

The second substrate layer 154 (i.e., the MDM layer) is disposed directly on the ground plane 160. The ground plane 160 is formed from various electrically conductive materials such as, for example, metal. The ground plane 160 provides a necessary reference plane for the patch dipole elements 152, and can serve as a reflector to enhance radiation in a targeted direction. According to a non-limiting embodiment, the ground plane 160 can include one or more metal posts 112, which can be disposed through one or more holes 109 formed in the third substrate 108 and the second substrate 106 to stabilize the stacked substrate layers of the patch antenna 150.

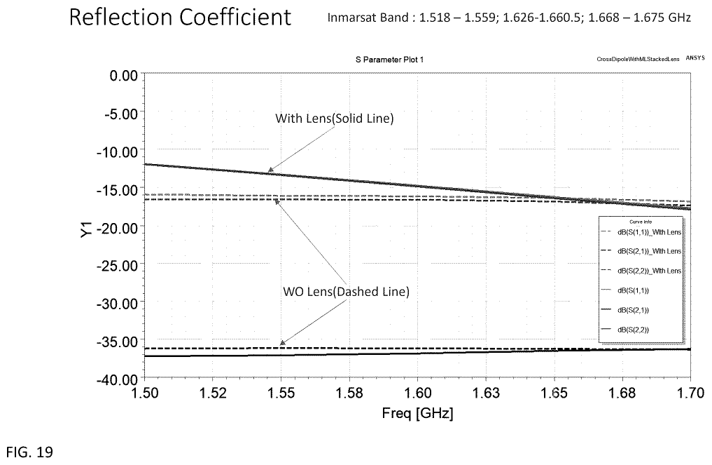

FIGS. 19 through 23 are diagrams depicting various performance characteristics of the patch antenna 150 including the parse gradient dielectric cover 250 compared to the patch antenna 150 excluding the parse gradient dielectric cover 250.

FIG. 19 compares the reflection coefficient of the patch antenna 150 including the parse gradient dielectric cover 250 compared to the patch antenna 150 excluding the parse gradient dielectric cover 250.

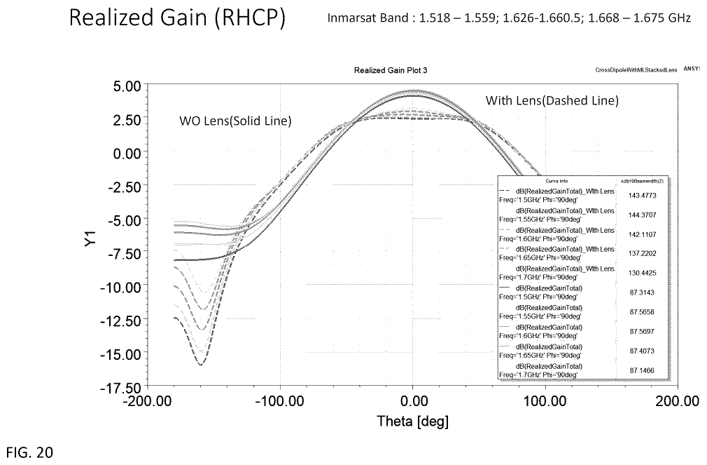

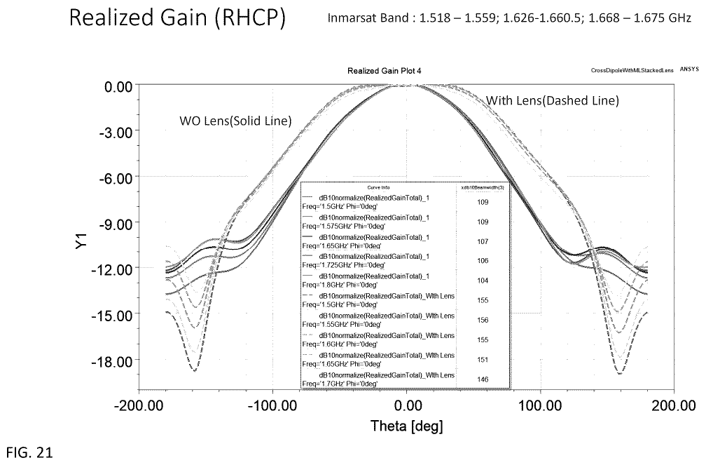

FIG. 20 compares the realized gain for RHCP of the patch antenna 150 including the parse gradient dielectric cover 250 at frequencies ranging from 1.5 GHz to 1.7 GHz with a horizontal angular direction (e.g., azimuth or boresight direction) set at 90 degrees compared to the patch antenna 150 excluding the parse gradient dielectric cover 250 at frequencies ranging from 1.5 GHz to 1.7 GHz with a horizontal angular direction (e.g., azimuth or boresight direction) set at 90 degrees.

FIG. 21 compares the realized gain for RHCP of the patch antenna 150 including the parse gradient dielectric cover 250 at frequencies ranging from 1.5 GHz to 1.7 GHz with a horizontal angular direction (e.g., e.g., azimuth or boresight direction) set at 0 degrees compared to the patch antenna 150 excluding the parse gradient dielectric cover 250 at frequencies ranging from 1.5 GHz to 1.7 GHz with a horizontal angular direction (e.g., azimuth or boresight direction) set at 0 degrees.

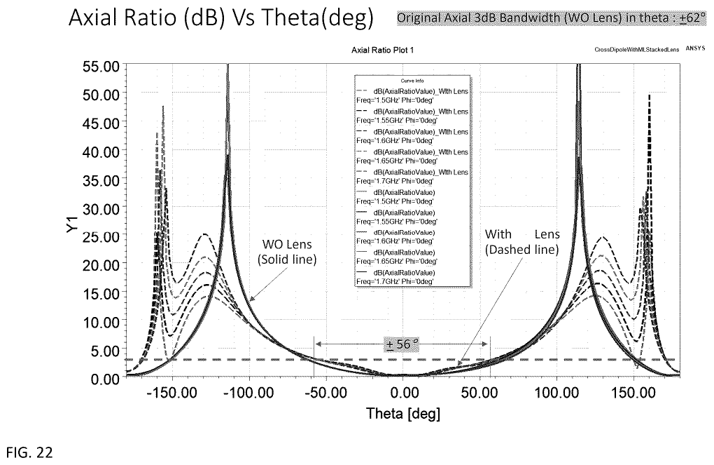

FIG. 22 compares the axial ratio (dB) Vs. theta (deg) of the patch antenna 150 including the parse gradient dielectric cover 250 compared to the patch antenna 150 excluding the parse gradient dielectric cover 250.

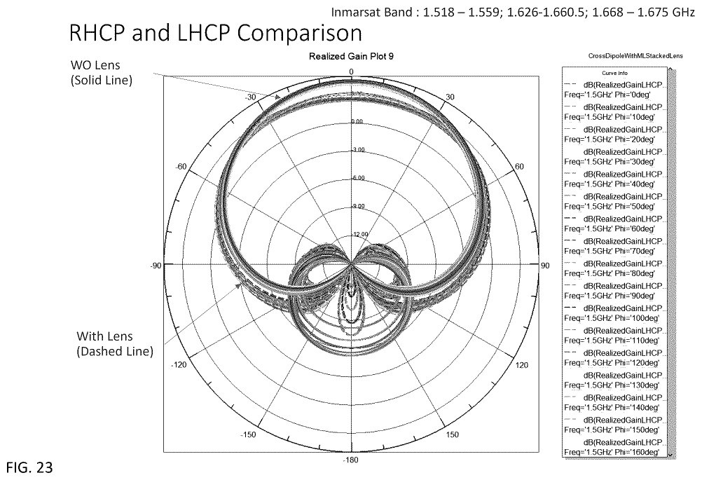

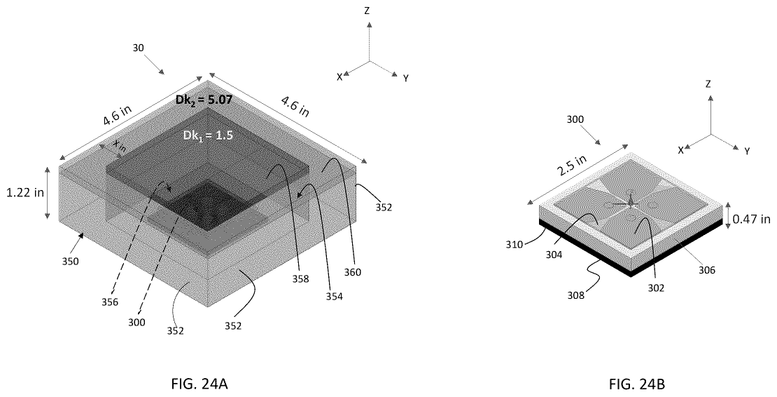

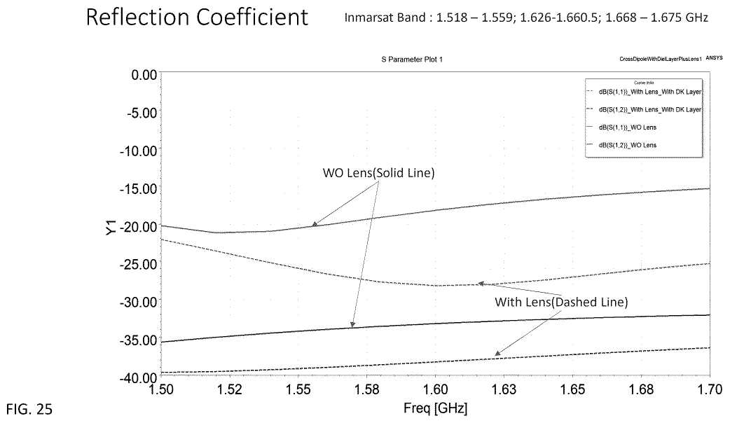

FIG. 23 compares the RHCP Vs. LHCP of the patch antenna 150 including the parse gradient dielectric cover 250 at a frequency of 1.5 GHz and a horizontal angular direction (e.g., e.g., azimuth or boresight direction) ranging from 0 degrees to 160 degrees compared to the patch antenna 100 excluding the parse gradient dielectric cover 200 at a frequency set at 1.5 GHz and a horizontal angular direction (e.g., e.g., azimuth or boresight direction) ranging from 0 degrees to 160 degrees.

Turning now to FIGS. 24A and 24B, an antenna assembly 30 is illustrated according to another non-limiting embodiment of the present disclosure. The antenna assembly 30 includes a patch antenna 300 and a parse gradient dielectric cover 350. The patch antenna 300 includes EM radiating elements 302, a first substrate 304, a second substrate 306, a third substrate 308, and a ground plane 310. The combination of the first substrate 304, the second substrate 306, the third substrate 308, and the ground plane 310 are stacked on top of one another to form a substrate stack. In other embodiments, the antenna assembly 30 can utilize stacked substrate of the patch antenna 100 ad described above without departing from the scope of the invention.

The radiating elements 302 can have various profiles including, but not limited to, square-shaped, rectangular-shaped, and circular shaped. Likewise, the first substrate 304, the second substrate 306, the third substrate 308, and the ground plane 310 can have various profiles including, but not limited to, square-shaped, rectangular-shaped, and circular shaped.

The radiating elements 302 comprise an electrically conductive material, which is formed on a first substrate 304 comprising a dielectric material. The electrically conductive material of the radiating elements 302 includes various metals such as, for example, copper (Cu). As described herein, the radiating elements 302 can be arranged as orthogonal patch dipole radiating elements (also referred to herein as patch dipoles) to establish a cross-dipole configuration, referred to herein as a cross-dipole. The size of each patch dipole radiating element 302 can be designed according to a target operating frequency of the patch antenna 300. According to a non-limiting embodiment, each patch dipole radiating element 302 is approximately half the wavelength of the center frequency in the first substrate's medium, considering the effect of the first substrate's dielectric constant. This arrangement allows the patch antenna 300 to radiate or receive circularly polarized waves, which is advantageous in reducing signal degradation due to multipath fading in mobile environments. In addition, the ability to provide circular polarization makes the patch antenna 300 suitable for applications where the orientation of the transmitter or receiver varies, such as in mobile satellite communications.

The first substrate 304, e.g., the “low-loss substrate 304” upon which the metal patch dipoles 302 are formed, is formed from various low-loss materials having a dielectric constant ranging, for example, from about 2.9 to about 3.1, with a preferred dielectric constant of Dk=3.0. The first substrate 304 also has a thickness ranging, for example, from about 0.02 inches (0.508 mm) in to about 0.05 inches (1.27 mm), and in some embodiments has a thickness of 0.03 inches (0.762 mm). The Dk₁ of the first substrate 304 determines a velocity of the electromagnetic wave propagating through the first substrate 304, and thus controls the resonant frequency of the patch antenna 300. The thickness and Dk₁ of the first substrate 304 also influence the impedance bandwidth and radiation efficiency of patch antenna 300. By adjusting these parameters, the patch antenna 300 can be optimized to operate according to specific performance requirements such as bandwidth, gain, and size.

The second substrate 306 on which the first substrate 304 is disposed has a thickness (e.g., along the Z-axis) ranging, for example, from about 0.3050 inches (7.747 mm) to about 0.3060 inches (7.7724 mm), with a thickness preferable set at 0.3057 inches (7.76478 mm), a length (e.g. along the Y-axis) ranging from, for example, from about 2.0 inches (50.8 mm) to about 3.0 inches (76.2 mm), with a length preferably set at 2.5 inches (63.5 mm), and a width (e.g. along the X-axis) ranging, for example, from about 2.0 inches (50.8 mm) to about 3.0 inches (76.2 mm), with a width preferably set at 2.5 inches (63.5 mm). The second substrate 306 also has a Dk₂ ranging from about 1.0 to about 1.4, with a Dk₂ of 1.3.

The stacked combination of the first substrate 304 and the second substrate 306 can enhance the bandwidth of the patch antenna 300, while the contrasting dielectric constants of the two substrate layers 304 and 306 can facilitate a broader impedance bandwidth. The contrasting dielectric constants also allow for a certain degree of freedom in controlling the overall thickness of the patch antenna 300, which is particularly useful when aiming to manufacture a cross-dipole antenna having a low-profile antenna without compromising performance.

The third substrate 308 on which the second substrate 306 is disposed has a thickness ranging, for example, from about 0.135 inches (3.429 mm) to about 0.140 inches (3.556 mm), with a thickness preferably set at 0.318 inches (8.0772 mm), a length (e.g. along the Y-axis) ranging from, for example, from about 2.0 inches (50.8 mm) to about 3.0 inches (76.2 mm), with a length preferably set at 2.5 inches (63.5 mm), and a width (e.g. along the X-axis) ranging, for example, from about 2.0 inches (50.8 mm) to about 3.0 inches (76.2 mm), with a width preferably set at 2.5 inches (63.5 mm). The third substrate 308, e.g., the magnetodielectric substrate 308, comprises a magnetodielectric material (MDM), which can include hexagonal ferrite particles and PTFE or PPS polymer. The hexagonal ferrite material can include Z-type (Co2Z), or Y-type (Co2Y) hexaferrite. The MDM has a Dk₃ ranging from about 11.90 and 12.05, with a Dk₃ preferably set at 11.98, and has permeability (μ) ranging from about 6.50 and 7.60, with a preferred permeability (μ) set at 6.55.

The third substrate 308 (i.e., the magnetodielectric substrate) is disposed directly on the ground plane 310. The ground plane 310 is formed from various electrically conductive materials such as, for example, metal. The ground plane 310 provides a necessary reference plane for the patch dipole elements 302, and can serve as a reflector to enhance radiation in a targeted direction. As described herein, the ground plane 310 can include one or more metal posts 312, which can be disposed through one or more holes formed in the third substrate 308 and the second substrate 306 to stabilize the stacked substrate layers of the patch antenna 300.

With continued reference to FIGS. 24A, the parse gradient dielectric cover 350 is illustrated in greater detail. The parse gradient dielectric cover 350 includes sidewalls 352 and a gradient lens 354. According to a non-limiting embodiment, the cover 350 has a total thickness (e.g., along the Z-axis) ranging, for example, from about 1.20 inches (30.48 mm) to about 1.25 inches (31.75 mm), with a total thickness preferable set at 1.22 inches (30.988 mm), a total length (e.g. along the Y-axis) ranging from, for example, from about 4.0 inches (101.6 mm) to about 5.0 inches (127 mm), with a total length preferably set at 4.6 inches (116.84 mm), and a total width (e.g. along the X-axis) ranging, for example, from about 4.0 inches (101.6 mm) to about 5.0 inches (127 mm), with a total width preferably set at 4.6 inches (116.84 mm).

The sidewalls 352 extend orthogonally from the gradient lens 354 and define an inner cavity 356 configured to receive the patch antenna 300. The sidewalls 352 extend from a bottom end to a top end (e.g., along the Z-axis) to define a sidewall height. Each sidewall 352 has a vertical height (e.g., extending along the Z-axis) ranging, for example, from about 1.20 inches (30.48 mm) to about 1.25 inches (31.75 mm), with a height preferable set at 1.22 inches (30.988 mm), and a thickness (e.g., extending along the Y-axis) of about 0.55 inches (13.97 mm) to about 0.60 inches (15.24 mm), and in some embodiments has a thickness of 0.58 inches (14.732 mm).

The sidewalls 352 are formed from a dielectric material having a dielectric constant ranging, for example, Dk=1.0 to Dk=5.5. Accordingly, the dielectric sidewalls 352 reduce, or even completely prevent, reflection back to the source and reduces the narrow impedance bandwidth behavior to the source such that the electric fields produced by the patch antenna 300 are refracted through the dielectric material.

The gradient lens 354 is disposed on the top of the sidewalls 352 (e.g., the top ends of the sidewalls) to completely cover the patch antenna 300 disposed in the cavity 356. The lens 354 has a thickness (e.g., along the Z-axis) ranging, for example, from about 0.11 inches (2.794 mm) to about 0.20 (5.08 mm), with a thickness preferable set at 0.15 inches (3.81 mm), a length (e.g. along the Y-axis) ranging from, for example, from about 4.0 inches (101.6 mm) to about 5.0 inches (127 mm), with a total length preferably set at 4.6 inches (116.84 mm), and a total width (e.g. along the X-axis) ranging, for example, from about 4.0 inches (101.6 mm) to about 5.0 inches (127 mm), with a total width preferably set at 4.6 inches (116.84 mm).

The lens 354 establishes a gradient dielectric constant (Dk) using two or more gradient lens portions having different dielectric constants. According to a non-limiting embodiment, the lens 354 includes a first lens portion 358 and a second lens portion 360 that surrounds the first lens portion 358. In some embodiments, the first lens portion 358 has a first dielectric constant Dk_{L1} ranging, for example, from about 1.0 to about 2.5. In some embodiments, the first lens portion 358 has a Dk_{L1} ranging, for example, from about 1.3 to about 1.7 with a preferred Dk_{L1} set at 1.5. In one or more non-limiting embodiments, the first lens portion 358 with the Dk_{L1} extends from the center of the lens 354 until reaching the second lens portion 360, and has a length ranging, for example, from about 4.0 inches (101.6 mm) to about 4.5 inches (114.3 mm) and preferably, 4.2 inches (106.68 mm).

The second lens portion 360 extends from the first portion 358 until reaching the ends of the lens 354. The second lens portion 360 has a second dielectric constant Dk_{L2} ranging, for example, from about 2.3 to about 5.10. In some embodiments, the second lens portion 360 has a Dk_{L2} ranging, for example, from about 5.00 to about 5.10, with a preferred Dk_{L2} set at 5.07. In one or more non-limiting embodiments, the second lens portion 360 extends from the first lens portion 358 to the lens ends at a distance ranging, for example, from about 0.97 inches (24.638 mm) to about 0.98 inches (24.892 mm), and preferably, 0.974 inches (24.7396 mm).

Although the example gradient lens 354 is described as having two discrete dielectric constant values (e.g., Dk_{L1}=1.5 and Dk_{L2}=5.07), it should be appreciated that gradient lens 354 can have a gradient dielectric constant that constantly varies from a larger Dk value at the ends of lens 354 down to a smaller Dk value at the middle of the lens 354. For example, the gradient lens 354 can have a Dk_{L2}=5.07 at the at the ends of lens 354 and a Dk_{L1}=1.5 at the middle of the lens 354, with an intermediate lens region with dielectric constant values (Dk_{LX}) that gradually decrease from the second lens portion 360 to the first lens portion 358.

FIGS. 25 through 30 are diagrams depicting various performance characteristics of the patch antenna 300 including the parse gradient dielectric cover 350 compared to the patch antenna 300 excluding the parse gradient dielectric cover 350.

FIG. 25 compares the reflection coefficient of the patch antenna 300 including the parse gradient dielectric cover 350 compared to the patch antenna 300 excluding the parse gradient dielectric cover 350.

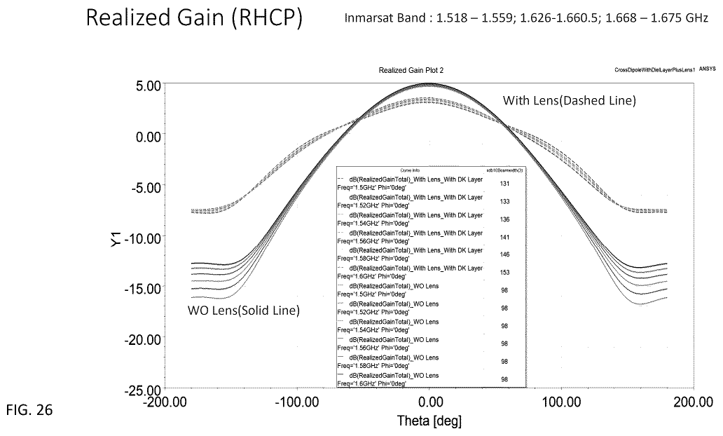

FIG. 26 compares the realized gain for RHCP of the patch antenna 300 including the parse gradient dielectric cover 350 at frequencies ranging from 1.5 GHz to 1.6 GHz compared to the patch antenna 300 excluding the parse gradient dielectric cover 350 at frequencies ranging from 1.5 GHz to 1.6 GHz.

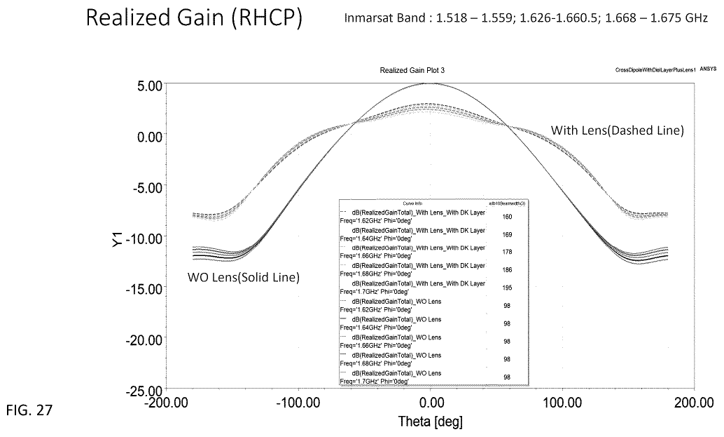

FIG. 27 compares the realized gain for RHCP of the patch antenna 300 including the parse gradient dielectric cover 350 at frequencies ranging from 1.62 GHz to 1.7 GHz compared to the patch antenna 300 excluding the parse gradient dielectric cover 350 at frequencies ranging from 1.62 GHz to 1.7 GHZ.

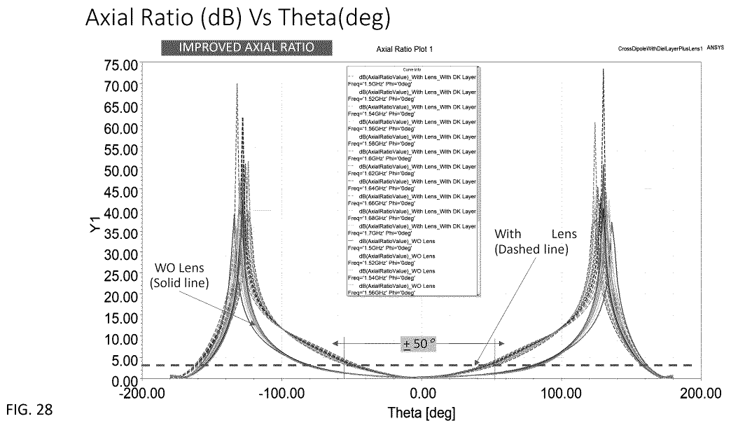

FIG. 28 compares the axial ratio (dB) Vs. theta (deg) of the patch antenna 300 including the parse gradient dielectric cover 350 compared to the patch antenna 300 excluding the parse gradient dielectric cover 350.

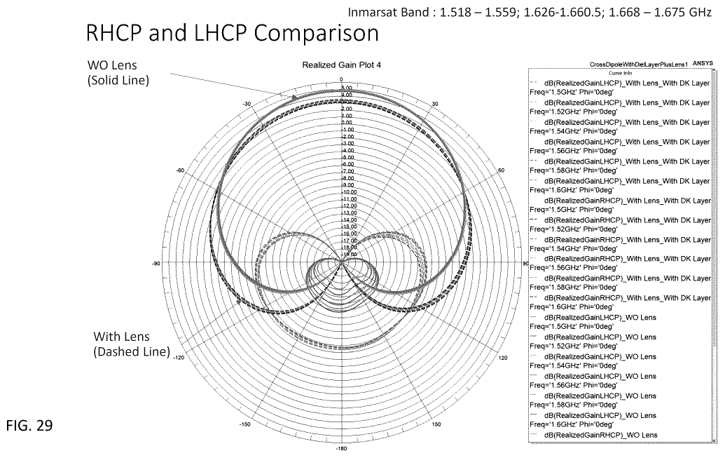

FIG. 29 compares the RHCP Vs. LHCP of the patch antenna 300 including the parse gradient dielectric cover 350 at frequencies ranging from 1.5 GHz to 1.6 GHz compared to the patch antenna 300 excluding the parse gradient dielectric cover 350 at frequencies ranging from 1.5 GHz to 1.6 GHz.

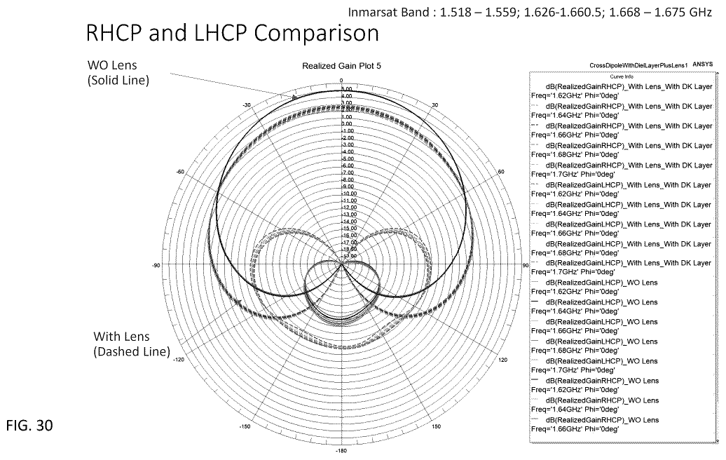

FIG. 30 compares the RHCP Vs. LHCP of the patch antenna 300 including the parse gradient dielectric cover 350 at frequencies ranging from 1.62 GHz to 1.7 GHz compared to the patch antenna 300 excluding the parse gradient dielectric cover 350 at frequencies ranging from 1.62 GHz to 1.7 GHz.

FIG. 31 illustrates a parse gradient dielectric cover 450 that can be utilized with the patch antenna 300 to establish an antenna assembly 40 according to another non-limiting embodiment of the present disclosure. The details of the patch antenna 300 are described above and will not be repeated for the sake of brevity. As described herein, the patch antenna 300 can be covered completely by the parse gradient dielectric cover 450 to increase bending of the wavefront in the far FOV. Accordingly, a wider FOV of + or −80 degrees is achieved to provide improved Horizon coverage.

The parse gradient dielectric cover 450 includes tapered sidewalls 452 and a gradient lens 454. According to a non-limiting embodiment, the cover 450 has a total thickness (e.g., along the Z-axis) ranging, for example, from about 1.20 inches (30.48 mm) to about 1.25 inches (31.75 mm), with a total thickness preferable set at 1.22 inches (30.988 mm), a total length (e.g. along the Y-axis) ranging from, for example, from about 4.0 inches (101.6 mm) to about 5.0 inches (127.0 mm), with a total length preferably set at 4.6 inches (116.84 mm), and a total width (e.g. along the X-axis) ranging, for example, from about 4.0 inches (101.6 mm) to about 5.0 inches (127.0 mm), with a total width preferably set at 4.6 inches (116.84 mm).

The tapered sidewalls 452 define an inner cavity (not shown in FIG. 31) configured to receive the patch antenna 300. The sidewalls 452 extend from a bottom end to a top end (e.g., along the Z-axis) to define a sidewall height. Each sidewall 452 has a vertical height (e.g., extending along the Z-axis) ranging, for example, from about 1.20 inches (30.48 mm) to about 1.25 inches, (31.75 mm) with a height preferable set at 1.22 inches (30.988 mm), and a thickness (e.g., extending along the Y-axis) of about 0.55 inches (13.97 mm) to about 0.60 inches (15.24 mm), and in some embodiments has a thickness of 0.58 inches (14.732 mm).

The tapered sidewalls 452 are formed from a dielectric material having a dielectric constant ranging, for example, Dk=1.0 to Dk=5.5. Accordingly, the sidewalls 452 reduce, or even completely prevent, reflection back to the source and reduces the narrow impedance bandwidth behavior to the source such that the electric fields produced by the patch antenna 300 are refracted through the dielectric material.

The gradient lens 454 is disposed on the top of the sidewalls 452 (e.g., the top ends of the sidewalls) to completely cover the patch antenna 300 disposed in the cavity 456. The lens 454 has a thickness (e.g., along the Z-axis) ranging, for example, from about 0.20 inches (5.08 mm) to about 0.30 (7.62 mm), with a thickness preferable set at 0.25 inches (6.35 mm), a length (e.g. along the Y-axis) ranging from, for example, from about 4.0 inches (101.6 mm) to about 5.0 inches (127.0 mm), with a total length preferably set at 4.6 inches (116.84 mm), and a total width (e.g. along the X-axis) ranging, for example, from about 4.0 inches (101.6 mm) to about 5.0 inches (127.0 mm), with a total width preferably set at 4.6 inches (116.84 mm).

The lens 454 establishes a gradient dielectric constant using two or more gradient lens portions having different dielectric constants. According to a non-limiting embodiment, the lens 454 includes a first lens portion 458 and a second lens portion 460 that surrounds the first lens portion 458. In some embodiments, the first lens portion 458 has a first dielectric constant Dk_{L1} ranging, for example, from about 1.0 to about 2.5. In some embodiments, the first lens portion 458 has a Dk_{L1} ranging, for example, from about 1.3 to about 1.7 with a preferred first Dk_{L1} of 1.5. In one or more non-limiting embodiments, the first lens portion 458 with the Dk_{L1} extends from the center of the lens 454 until reaching the second lens portion 460, and has a length ranging, for example, from about 3.4 inches (86.36 mm) to about 3.5 inches (88.9 mm), and preferably, 3.453 inches (87.7062 mm).

The second lens portion 460 extends from the first portion 458 until reaching the ends of the lens 454. The second lens portion 460 has a second dielectric constant Dk_{L2} ranging, for example, from about 2.3 to about 5.10. In some embodiments, the second lens portion 460 has a Dk_{L2} ranging, for example, from about 5.00 to about 5.10, with a preferred Dk_{L2} of 5.07. In one or more non-limiting embodiments, the second lens portion 460 extends from the first lens portion 458 to the lens ends at a distance (X) ranging, for example, of about 0.97 inches (24.638 mm) to about 0.98 inches (24.892 mm), and preferably, 0.974 inches (24.7396 mm). According to a non-limiting embodiment, the corners of the second lens portion 460 and the corners of the first lens portion 458 are separated from one another by a distance (Y) ranging from 0.80 inches (20.32 mm) to 0.85 inches (21.59 mm), and in some embodiments is 0.83 inches (21.082 mm).

Although the example gradient lens 454 is described as having two discrete dielectric constant values (e.g., Dk_{L1}=1.5 and Dk_{L2}=5.07), it should be appreciated that gradient lens 454 can have a gradient dielectric constant that constantly varies from a larger Dk value at the ends of lens 454 down to a smaller Dk value at the middle of the lens 454. For example, the gradient lens 454 can have a dielectric Dk_{L2}=5.07 at the at the ends of lens 454 and a Dk_{L1}=1.5 at the middle of the lens 454, and an intermediate lens region with dielectric constant values Dk_{LX} that gradually decrease from the second lens portion 460 to the first lens portion 458.

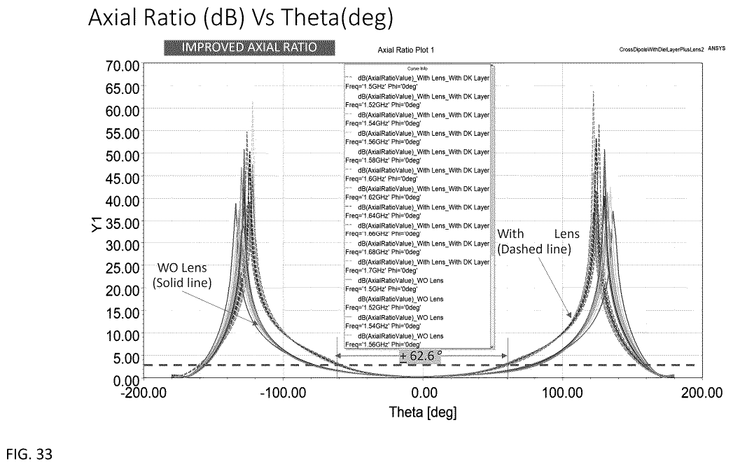

With continued reference to FIG. 31, the tapered sidewalls 452 extend inward toward the inner cavity to define a tapered profile. According to a non-limiting embodiment, the sidewalls 452 taper inward at an angle (e.g., a draft angle) ranging, for example, 20 degrees to 30 degrees, and in some embodiments tapers inward at an angle of 24 degrees. The tapered sidewalls 452 provide an improved axial ratio of about 62.6 degrees (see FIG. 33).

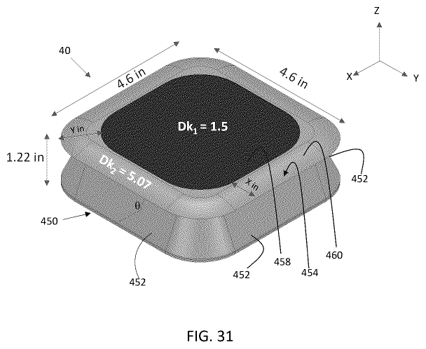

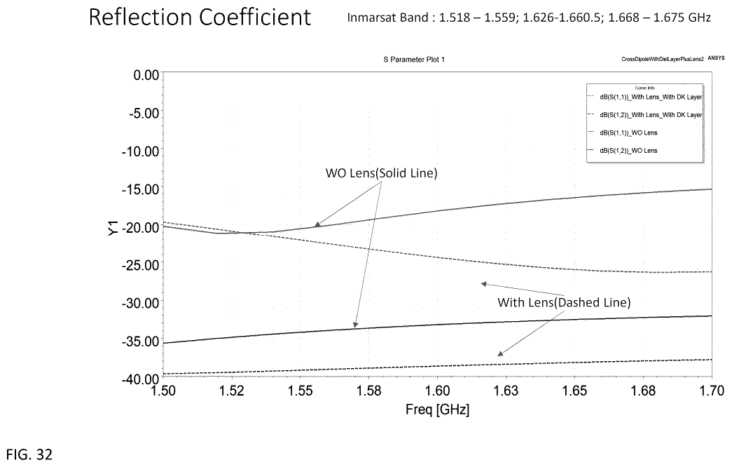

FIGS. 32 through 35 are diagrams depicting various performance characteristics of the patch antenna 300 including the parse gradient dielectric cover 450 with tapered sidewalls 452 compared to the patch antenna 300 excluding the parse gradient dielectric cover 450.

FIG. 32 compares the reflection coefficient of the patch antenna 300 including the parse gradient dielectric cover 450 compared to the patch antenna 300 excluding the parse gradient dielectric cover 450.

FIG. 33 compares the axial ratio (dB) Vs. theta (deg) of the patch antenna 300 including the parse gradient dielectric cover 450 compared to the patch antenna 300 excluding the parse gradient dielectric cover 450.

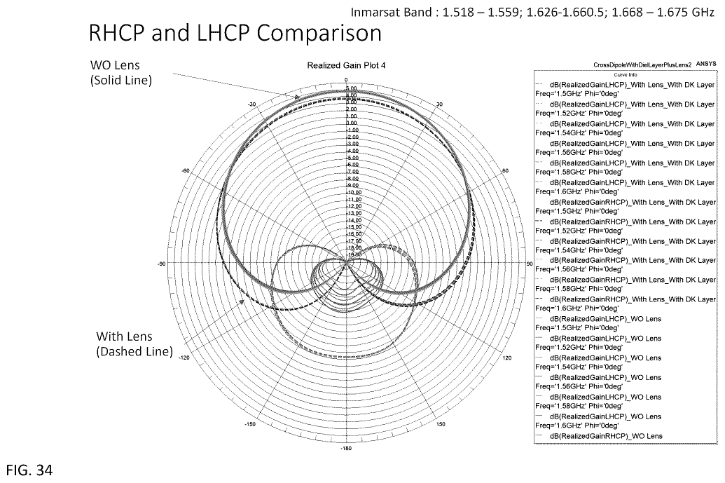

FIG. 34 compares the RHCP Vs. LHCP of the patch antenna 300

including the parse gradient dielectric cover 450 at frequencies ranging from 1.5 GHz to 1.6 GHz compared to the patch antenna 300 excluding the parse gradient dielectric cover 450 at frequencies ranging from 1.5 GHz to 1.6 GHz.

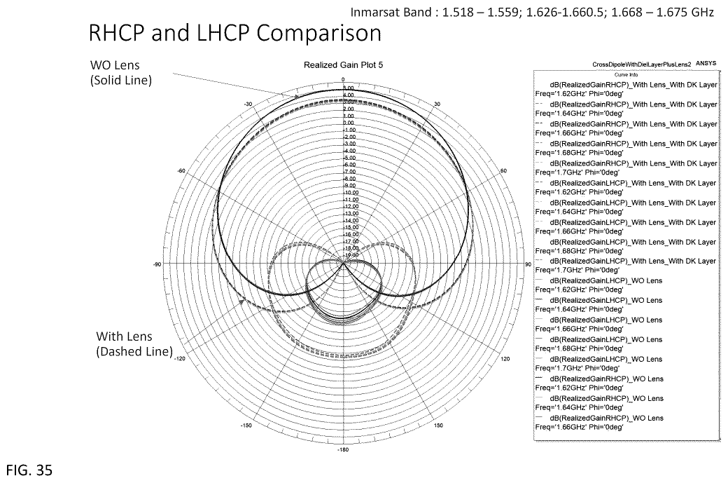

FIG. 35 compares the RHCP Vs. LHCP of the patch antenna 300 including the parse gradient dielectric cover 450 at frequencies ranging from 1.62 GHz to 1.7 GHz compared to the patch antenna 300 excluding the parse gradient dielectric cover 450 at frequencies ranging from 1.62 GHz to 1.7 GHz.

As described herein, various non-limiting of the present disclosure provide a cross-dipole patch antenna that is robust, efficient, while achieving a compact size capable of operating at L-Band frequencies. The intricacies of its design allow it to meet the stringent requirements of various communication applications, particularly those necessitating a small form factor and reliable performance in diverse orientations and conditions.

With respect to the several figures of FIGS. 1-35, it will be appreciated that various aspects of an embodiment are disclosed herein, which are in accordance with, but not limited to, at least the following aspects and/or combinations of aspects.

Aspect 1: An antenna assembly 10, comprising: a substrate stack 105 comprising a magnetodielectric material; at least one patch radiating element 102 on an upper surface of the substrate stack 105; and a dielectric cover 200 including a gradient lens 204 disposed over the substrate stack 105, wherein the gradient lens 204 includes a first lens portion having a first dielectric constant, Dk_{L1}, and a second lens portion having a second dielectric constant, Dk_{L2}, different from the first dielectric constant, Dk_{L1}.

Aspect 2: The antenna assembly of Aspect 1, wherein the at least one patch radiating element 102 comprises metal.

Aspect 3: The antenna assembly of Aspect 2, wherein the at least one patch radiating element 102 includes a plurality of patch radiating elements 102.

Aspect 4: The antenna assembly of Aspect 3, wherein the plurality of patch radiating elements 102 are arranged as orthogonal patch dipole radiating elements to establish a cross-dipole.

Aspect 5: The antenna assembly of Aspect 1, wherein the substrate stack 105 comprises: a low-loss substrate 104 comprising a low-loss material; and a magnetodielectric substrate 108 comprising the magnetodielectric material.

Aspect 6: The antenna assembly of Aspect 5, wherein the low-loss substrate has a dielectric constant, Dk1, ranging from 2.9 to 3.1.

Aspect 7: The antenna assembly of Aspect 5, wherein the magnetodielectric material has a dielectric constant, Dk3, ranging from 11.90 to 12.05, and permeability, μ, ranging from 6.50 to 7.60.

Aspect 8: The antenna assembly of Aspect 5, wherein the low-loss substrate 104 and the magnetodielectric substrate 108 are separated from one another by a layer of air with a dielectric constant of 1.0.

Aspect 9: The antenna assembly of Aspect 5, further comprising a dielectric substrate 106 interposed between the low-loss substrate 104 and the magnetodielectric substrate 108.

Aspect 10: The antenna assembly of Aspect 9, wherein the dielectric substrate 106 comprises a dielectric material having a dielectric constant, Dk2, ranging from 1.0 to 1.4.

Aspect 11: The antenna assembly of Aspect 10, wherein the dielectric constant, Dk2, is 1.3.

Aspect 12: The antenna assembly of Aspect 5, further comprising a ground plane 110 on which the magnetodielectric substrate 108 is disposed.

Aspect 13: The antenna assembly of Aspect 9, wherein the second lens portion 210 surrounds the first lens portion 208.

Aspect 14: The antenna assembly of Aspect 13, wherein the second dielectric constant, DkL2, that is greater than the first dielectric constant, DkL1.

Aspect 15: The antenna assembly of Aspect 13, wherein the first dielectric constant, DkL1, ranges from 1.0 to 2.7, and the second dielectric constant, DkL2, ranges from 2.5 to 5.10.

Aspect 16: The antenna assembly of Aspect 15, wherein the dielectric cover 200 further comprises sidewalls 202 extending orthogonally from the gradient lens 204 and defining an inner cavity 206 in which the substrate stack is disposed.

Aspect 17: The antenna assembly of Aspect 16, wherein the sidewalls comprises a dielectric material.

Aspect 18: The antenna assembly of Aspect 17, wherein the sidewalls and gradient lens extend along an X-axis to define a length, a Y-axis to define a width, and a Z-axis to define a thickness.

Aspect 19: The antenna assembly of Aspect 18, wherein: the first dielectric constant, DkL1, is 2.5; the second dielectric constant, DkL2, is 2.9; the length is 6.15 inches (156.21 mm); the width is 6.15 inches (156.21 mm); and the thickness is 1.97 inches (50.038 mm).

Aspect 20: The antenna assembly of Aspect 18, wherein: the first dielectric constant, DkL1, is 1.50; the second dielectric constant, DkL2, is 5.07; the length is 4.6 inches (116.84 mm); the width is 6.15 inches (116.84 mm); and the thickness is 1.22 inches (30.988 mm).

Aspect 21: The antenna assembly of Aspect 20, wherein the sidewalls 452 extend inward toward the inner cavity to define a tapered profile.

Aspect 22: The antenna assembly of Aspect 21, wherein the sidewalls 452 taper inward at an draft angle ranging from 20 degrees to 30 degrees.

Aspect 23 The antenna assembly of Aspect 13, wherein the gradient lens includes an intermediate lens region with one or more dielectric constant values, DkLX, that gradually decrease from the second lens portion having DkL2 to the first lens portion having DkL1.

Aspect 24: The antenna assembly of Aspect 8, wherein the dielectric cover 200 comprises: a base 253 having a circular profile defined by a first diameter; and a circular sidewall 252 extending orthogonally from the base and defining an inner cavity 257 configured to receive the substrate stack, wherein the gradient lens 204 is disposed on an upper surface of the circular sidewall and has a circular profile defined by a second diameter.

Aspect 52: The antenna assembly of Aspect 24, wherein: the second dielectric constant, DkL2 is 2.59; the first diameter is 12 inches (304.8 mm); and the second diameter is 9 inches (228.6 mm).

Aspect 26: A dielectric cover 200 configured to increase a field of view (FOV) of a patch antenna 100, the dielectric cover 200 comprising: at least one sidewall 202 defining an inner cavity 206 configured to receive the patch antenna 100; a gradient lens 204 disposed on an upper surface of the at least one sidewall, wherein the gradient lens 204 includes a first lens portion having a first dielectric constant, DkL1, and a second lens portion having a second dielectric constant, DkL2, different from the first dielectric constant, DkL1.

Aspect 27: The dielectric cover of Aspect 26, wherein the second dielectric constant, DkL2, that is greater than the first dielectric constant, DkL1.

Aspect 28: The dielectric cover of Aspect 27, wherein the first dielectric constant, DkL1, ranges from 1.0 to 2.7, and the second dielectric constant, DkL2, ranges from 2.5 to 5.10.

Aspect 29: The antenna assembly of Aspect 17, wherein the at least one sidewall includes a plurality of sidewalls, each of the sidewalls and the gradient lens extends along an X-axis to define a length, a Y-axis to define a width, and a Z-axis to define a thickness

Aspect 30: The dielectric cover of Aspect 28, wherein the first dielectric constant, DkL1, is 2.5; the second dielectric constant, DkL2, is 2.9; the length is 6.15 inches (156.21 mm); the width is 6.15 inches (156.21 mm); and the thickness is 1.97 inches (50.038 mm).

Aspect 31: The dielectric cover of Aspect 28, wherein: the first dielectric constant, DkL1, is 1.50; the second dielectric constant, DkL2, is 5.07; the length is 4.6 inches (116.84 mm); the width is 6.15 inches (116.84 mm); and the thickness is 1.22 inches (30.988 mm).

Aspect 32: The dielectric cover of Aspect 31, wherein the sidewalls 452 extend inward toward the inner cavity to define a tapered profile.

Aspect 33: The dielectric cover of Aspect 32, wherein the sidewalls 452 taper inward at an draft angle ranging from 20 degrees to 30 degrees.

Aspect 34: The dielectric cover of Aspect 28, wherein the gradient lens includes an intermediate lens region with one or more dielectric constant values, DkLX, that gradually decrease from the second lens portion having DkL2 to the first lens portion having DkL1.

Aspect 35: The dielectric cover of Aspect 28, wherein the dielectric cover 200 comprises: a base 253 having a circular profile defined by a first diameter; and a circular sidewall 252 extending orthogonally from the base and defining an inner cavity 257 configured to receive the patch antenna, wherein the gradient lens 204 is disposed on an upper surface of the circular sidewall and has a circular profile defined by a second diameter.

Aspect 36: The dielectric cover of Aspect 35, wherein: the second dielectric constant, DkL1 is 2.59; the first diameter is 12 inches (304.8 mm); and the second diameter is 9 inches (228.6 mm).

While an invention has been described herein with reference to example embodiments, it will be understood by those skilled in the art that various changes may be made and equivalents may be substituted for elements thereof without departing from the scope of the claims. Many modifications may be made to adapt a particular situation or material to the teachings of the invention without departing from the essential scope thereof. Therefore, it is intended that the invention not be limited to the particular embodiment or embodiments disclosed herein as the best or only mode contemplated for carrying out this invention, but that the invention will include all embodiments falling within the scope of the appended claims. In the drawings and the description, there have been disclosed example embodiments and, although specific terms and/or dimensions may have been employed, they are unless otherwise stated used in a generic, exemplary and/or descriptive sense only and not for purposes of limitation, the scope of the claims therefore not being so limited. When an element such as a layer, film, region, substrate, or other described feature is referred to as being “on” or in “engagement with” another element, it can be directly on or engaged with the other element, or intervening elements may also be present. In contrast, when an element is referred to as being “directly on” or “directly engaged with” another element, there are no intervening elements present. The use of the terms first, second, etc. do not denote any order or importance, but rather the terms first, second, etc. are used to distinguish one element from another. The use of the terms a, an, etc. do not denote a limitation of quantity, but rather denote the presence of at least one of the referenced item. The use of the terms “top”, “bottom”, “up”, “down”, “left”, “right”, “front”, “back”, etc., or any reference to orientation, do not denote a limitation of structure, as the structure may be viewed from more than one orientation, but rather denote a relative structural relationship between one or more of the associated features as disclosed herein. The term “comprising” as used herein does not exclude the possible inclusion of one or more additional features. Any background information provided herein is provided to reveal information believed by the applicant to be of possible relevance to the invention disclosed herein. No admission is necessarily intended, nor should be construed, that any of such background information constitutes prior art against an embodiment of the invention disclosed herein.

1. An antenna assembly 10, comprising:
a substrate stack 105 comprising a magnetodielectric material;
at least one patch radiating element 102 on an upper surface of the substrate stack 105; and
a dielectric cover 200 including a gradient lens 204 disposed over the substrate stack 105,
wherein the gradient lens 204 includes a first lens portion having a first dielectric constant, Dk_{L1}, and a second lens portion having a second dielectric constant, Dk_{L2}, different from the first dielectric constant, Dk_{L1}.

2. The antenna assembly of claim 1, wherein the at least one patch radiating element 102 comprises metal.

3. The antenna assembly of claim 2, wherein the at least one patch radiating element 102 includes a plurality of patch radiating elements 102.

4. The antenna assembly of claim 3, wherein the plurality of patch radiating elements 102 are arranged as orthogonal patch dipole radiating elements to establish a cross-dipole.

5. The antenna assembly of claim 1, wherein the substrate stack 105 comprises:
a low-loss substrate 104 comprising a low-loss material; and
a magnetodielectric substrate 108 comprising the magnetodielectric material.

6. The antenna assembly of claim 5, wherein the low-loss substrate has a dielectric constant, Dk₁, ranging from 2.9 to 3.1.

7. The antenna assembly of claim 5, wherein the magnetodielectric material has a dielectric constant, Dk₃, ranging from 11.90 to 12.05, and permeability, μ, ranging from 6.50 to 7.60.

8. The antenna assembly of claim 5, wherein the low-loss substrate 104 and the magnetodielectric substrate 108 are separated from one another by a layer of air with a dielectric constant of 1.0.

9. The antenna assembly of claim 5, further comprising a dielectric substrate 106 interposed between the low-loss substrate 104 and the magnetodielectric substrate 108.

10. The antenna assembly of claim 9, wherein the dielectric substrate 106 comprises a dielectric material having a dielectric constant, Dk₂, ranging from 1.0 to 1.4.

11. The antenna assembly of claim 10, wherein the dielectric constant, Dk₂, is 1.3.

12. The antenna assembly of claim 5, further comprising a ground plane 110 on which the magnetodielectric substrate 108 is disposed. 13 The antenna assembly of claim 9, wherein the second lens portion 210 surrounds the first lens portion 208.

14. The antenna assembly of claim 13, wherein the second dielectric constant, Dk_{L2}, that is greater than the first dielectric constant, Dk_{L1}.

15. The antenna assembly of claim 13, wherein the first dielectric constant, Dk_{L1}, ranges from 1.0 to 2.7, and the second dielectric constant, Dk_{L2}, ranges from 2.5 to 5.10.

16. The antenna assembly of claim 15, wherein the dielectric cover 200 further comprises sidewalls 202 extending orthogonally from the gradient lens 204 and defining an inner cavity 206 in which the substrate stack is disposed.

17. The antenna assembly of claim 16, wherein the sidewalls comprises a dielectric material.

18. The antenna assembly of claim 17, wherein the sidewalls and the gradient lens extend along an X-axis to define a length, a Y-axis to define a width, and a Z-axis to define a thickness.

19. The antenna assembly of claim 18, wherein:
the first dielectric constant, Dk_{L1}, is 2.5;
the second dielectric constant, Dk_{L2}, is 2.9;
the length is 6.15 inches (156.21 mm);
the width is 6.15 inches (156.21 mm); and
the thickness is 1.97 inches (50.038 mm).

20. The antenna assembly of claim 18, wherein:
the first dielectric constant, Dk_{L1}, is 1.50;
the second dielectric constant, Dk_{L2}, is 5.07;
the length is 4.6 inches (116.84 mm);
the width is 6.15 inches (116.84 mm); and
the thickness is 1.22 inches (30.988 mm).

21. The antenna assembly of claim 20, wherein the sidewalls 452 extend inward toward the inner cavity to define a tapered profile.

22. The antenna assembly of claim 21, wherein the sidewalls 452 taper inward at an draft angle ranging from 20 degrees to 30 degrees.

23. The antenna assembly of claim 13, wherein the gradient lens includes an intermediate lens region with one or more dielectric constant values, Dk_{LX}, that gradually decrease from the second lens portion having Dk_{L2} to the first lens portion having Dk_{L1}.

24. The antenna assembly of claim 8, wherein the dielectric cover 200 comprises:
a base 253 having a circular profile defined by a first diameter; and
a circular sidewall 252 extending orthogonally from the base and defining an inner cavity 257 configured to receive the substrate stack,
wherein the gradient lens 204 is disposed on an upper surface of the circular sidewall and has a circular profile defined by a second diameter.

25. The antenna assembly of claim 24, wherein:
the second dielectric constant, Dk_{L2} is 2.59;
the first diameter is 12 inches (304.8 mm); and
the second diameter is 9 inches (228.6 mm).
